(19) United States
(12) Patent Application Publication
(10) Pub. No.: US 2015/0035881 A1
(43) Pub. Date: Feb. 5, 2015

(54) METHOD OF MANUFACTURING COLOR CONTACT LENS

(71) Applicant: JUMBALL INDUSTRIES CORP., Taoyuan County (TW)

(72) Inventors: Fong Chen CHOU, Taoyuan County (TW); Ming Yi CHOU, Taoyuan County (TW)

(73) Assignee: JUMBALL INDUSTRIES CORP., Taoyuan County (TW)

(21) Appl. No.: 14/445,632

(22) Filed: Jul. 29, 2014

(30) Foreign Application Priority Data
Aug. 2, 2013 (TW) 102127718

(51) Int. Cl. G02C 13/00; G02C 7/04

(52) U.S. Cl. CPC G02C 13/001; G02C 7/046
USPC 347/2

(57) ABSTRACT

A method of manufacturing color contact lens includes the steps of providing a rubber pad having a pressure bearing surface and filling C/M/Y/B coloring agents in a first inkjet printer; causing the first inkjet printer to jet the C/M/Y/B coloring agents on the pressure bearing surface of the rubber pad to form a color image layer; transferring the color image layer from the rubber pad onto an inner surface of a concave mold; injecting a lens material into the concave mold; pressing a convex mold against the concave mold to form a lens layer on the color image layer; and curing the color image layer and the lens layer to form a color contact lens. With the method, the color image layer can be formed using the inkjet printer without an increased thickness, enabling mass production of relatively thin color contact lenses at shortened time and lowered defect rate.

### FIELD OF THE INVENTION

The present invention relates to a method of manufacturing contact lens, and more particularly to a method of manufacturing contact lens having a color image formed thereon.

### BACKGROUND OF THE INVENTION

Contact lenses are lenses placed directly on the surface of corneas to correct vision or protect eyes. As a consequence of mature contact lens technique and people's new demands for eyewear, contact lenses are now used not only for vision correction, but also for cosmetic or decorative purpose, such as changing the wearer's eye color and making the eyes look bigger.

Please refer to FIGS. 1 and 2. A currently adopted color contact lens manufacturing method includes the steps of applying a coloring agent 10 on a metal template 11 having an etched pattern 111 provided thereon, so as to form a pattern layer 12 on the metal template 11; transferring the pattern layer 12 from the metal template 11 onto a surface of a convex mold 13; injecting a lens material 14 into a concave mold 15; pressing the convex mold 13 against the concave mold 15; forming a colored lens 16 in between the two molds through a plasticizing process 161; waiting until the convex mold 13 and the concave mold 15 are cooled and then removing the colored lens 16 from the two molds; and finally, subjecting the colored lens 16 to a hydration process 162.

While the above-described color contact lens manufacturing method indeed shortens the time needed to form the color contact lens, the colored lens 16 so formed can usually present only one single color. When it is desired for the colored lens 16 to present multiple colors, a separate pattern layer transferring step is required to form each additional color. Therefore, when the number of the colors is increased, more metal templates 11 are needed to inevitably increase the manufacturing cost, which forms a big burden to the manufacturer.

Moreover, each additional pattern layer transferring step will increase an overall thickness of the pattern layers on the colored lens 16. That is, when a more complicated color pattern is to be formed on the colored lens 16, the overall thickness of the pattern layers on the colored lens 16 will be larger. And, the colored lens 16 with thicker pattern layers would have poor gas permeability to cause discomfort to the wearer's eyes.

Presently, a ferric chloride (FeCl₃) solution and a nitric acid solution are used to etch the surface of the metal template 11 to form the etched pattern 111. In the etching process, nitric oxide (NO) and nitrogen dioxide (NO₂) are produced, which not only form a serious pollution to people's living environment, but also cause serious harm to human body. Moreover, after etching the metal template 11, a hydrogen peroxide-based chemical solvent is used to develop the etched pattern 111. It is also known the hydrogen peroxide will cause a certain degree of harm to human skin and the use of hydrogen peroxide for such purpose has therefore long been officially prohibited by many European countries.

In view of the disadvantages of the conventional method of manufacturing color contact lens, it is tried by the inventor to develop an improved color contact lens manufacturing method, with which a color image layer showing a multicolor pattern can be formed without increasing an overall thickness of the contact lens, and the color image layer can be used in mass production of color contact lenses to shorten the manufacturing time and lower the defect rate of the finished color contact lenses.

### SUMMARY OF THE INVENTION

A primary object of the present invention is to provide a method of manufacturing color contact lens, according to which a color image layer showing a multicolor pattern can be quickly formed without increasing an overall thickness thereof and can be used in mass production of color contact lens, so that the time and cost needed to manufacture color contact lenses are effectively reduced and the defect rate of the finished color contact lenses is also lowered.

Another object of the present invention is to provide a method of manufacturing color contact lens, according to which a color image layer formed on the produced contact lens is not in direct contact with a wearer's cornea, so that the color contact lens is safer and more comfortable for wearing.

To achieve the above and other objects, the method of manufacturing color contact lens according to a first preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, and filling C/M/Y/B coloring agents in a first inkjet printer; causing the first inkjet printer to jet the C/M/Y/B coloring agents on the pressure bearing surface of the rubber pad to form a color image layer; pressing the rubber pad against an inner surface of a concave mold, so that the color image layer is transferred from the rubber pad onto the inner surface of the concave mold; injecting a lens material into the concave mold; pressing a convex mold against the concave mold to form a lens layer on a surface of the color image layer; subjecting the color image layer and the lens layer to a curing process to form a color contact lens; waiting until the concave and the convex mold are cooled and then removing the color contact lens from the two molds; and subjecting the color contact lens to a hydration process.

The method of manufacturing color contact lens according to a second preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, and filling C/M/Y/B coloring agents in a first inkjet printer; causing the first inkjet printer to jet the C/M/Y/B coloring agents on the pressure bearing surface of the rubber pad to form a color image layer; pressing the rubber pad against an outer surface of a convex mold, so that the color image layer is transferred from the rubber pad onto the outer surface of the convex mold; injecting a lens material into a concave mold; pressing the convex mold against the concave mold to form a lens layer on a surface of the color image layer; subjecting the color image layer and the lens layer to a curing process to form a color contact lens; waiting until the concave and the convex mold are cooled and then removing the color contact lens from the two molds; and subjecting the color contact lens to a hydration process.

The method of manufacturing color contact lens according to a third preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, and filling C/M/Y/B coloring agents in a first inkjet printer; causing the first inkjet printer to jet the C/M/Y/B coloring agents on the pressure bearing surface of the rubber pad to form a color image layer; providing a transparent coloring agent and filling it in a second inkjet printer, and causing the second inkjet printer to jet the transparent coloring agent on the color image layer to form a protective layer; pressing the rubber pad against an inner surface of a concave mold, so that the protective layer and the color image layer are sequentially transferred from the rubber pad onto the inner surface of the convex mold; injecting a lens material into the concave mold; pressing a convex mold against the concave mold to form a lens layer on a surface of the color image layer; subjecting the color image layer, the lens layer and the protective layer to a curing process to form a color contact lens; waiting until the concave and the convex mold are cooled and then removing the color contact lens from the two molds; and subjecting the color contact lens to a hydration process.

The method of manufacturing color contact lens according to a fourth preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, and filling C/M/Y/B coloring agents in a first inkjet printer; causing the first inkjet printer to jet the C/M/Y/B coloring agents on the pressure bearing surface of the rubber pad to form a color image layer; providing a transparent coloring agent and filling it in a second inkjet printer, and causing the second inkjet printer to jet the transparent coloring agent on the color image layer to form a protective layer; pressing the rubber pad against an outer surface of a convex mold, so that the protective layer and the color image layer are sequentially transferred from the rubber pad onto the outer surface of the convex mold; injecting a lens material into a concave mold; pressing the convex mold against the concave mold to form a lens layer on a surface of the color image layer; subjecting the color image layer, the protective layer and the lens layer to a curing process to form a color contact lens; waiting until the concave and the convex mold are cooled and then removing the color contact lens from the two molds; and subjecting the color contact lens to a hydration process.

The method of manufacturing color contact lens according to a fifth preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, providing a printing board formed of a thermoplastic elastomeric film and a phenol formaldehyde resin plate and having a printing surface, and filling C/M/Y/B coloring agents in a first inkjet printer; causing the first inkjet printer to jet the C/M/Y/B coloring agents on the printing surface of the printing board to form a color image layer; transferring the color image layer from the printing surface onto the pressure bearing surface of the rubber pad; pressing the rubber pad against an inner surface of a concave mold, so that the color image layer is transferred from the rubber pad onto the inner surface of the concave mold; injecting a lens material into the concave mold; pressing a convex mold against the concave mold to form a lens layer on a surface of the color image layer; subjecting the color image layer and the lens layer to a curing process to form a color contact lens; waiting until the concave and the convex mold are cooled and then removing the color contact lens from the two molds; and subjecting the color contact lens to a hydration process.

The method of manufacturing color contact lens according to a sixth preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, providing a printing board formed of a thermoplastic elastomeric film and a phenol formaldehyde resin plate and having a printing surface, and filling C/M/Y/B coloring agents in a first inkjet printer; causing the first inkjet printer to jet the C/M/Y/B coloring agents on the printing surface of the printing board to form a color image layer; transferring the color image layer from the printing surface onto the pressure bearing surface of the rubber pad; pressing the rubber pad against an outer surface of a convex mold, so that the color image layer is transferred from the rubber pad onto the outer surface of the convex mold; injecting a lens material into a concave mold; pressing the convex mold against the concave mold to form a lens layer on a surface of the color image layer; subjecting the color image layer and the lens layer to a curing process to form a color contact lens; waiting until the concave and the convex mold are cooled and then removing the color contact lens from the two molds; and subjecting the color contact lens to a hydration process.

The method of manufacturing color contact lens according to a seventh preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, providing a printing board formed of a thermoplastic elastomeric film and a phenol formaldehyde resin plate and having a printing surface, and filling C/M/Y/B coloring agents in a first inkjet printer; providing a transparent coloring agent and filling it in a second inkjet printer, and causing the second inkjet printer to jet the transparent coloring agent on the printing surface of the printing board to form a protective layer; causing the first inkjet printer to jet the C/M/Y/B coloring agents on the protective layer to form a color image layer, such that the protective layer is located between the printing surface of the printing board and the color image layer; transferring the color image layer and the protective layer from the printing surface onto the pressure bearing surface of the rubber pad, such that the color image layer is located between the pressure bearing surface of the rubber pad and the protective layer; pressing the rubber pad against an inner surface of a concave mold, so that the protective layer and the color image layer are sequentially transferred from the rubber pad onto the inner surface of the concave mold; injecting a lens material into the concave mold; pressing a convex mold against the concave mold to form a lens layer on a surface of the color image layer; subjecting the color image layer, the lens layer and the protective layer to a curing process to form a color contact lens; waiting until the concave and the convex mold are cooled and then removing the color contact lens from the two molds; and subjecting the color contact lens to a hydration process.

The method of manufacturing color contact lens according to an eighth preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, providing a printing board formed of a thermoplastic elastomeric film and a phenol formaldehyde resin plate and having a printing surface, and filling C/M/Y/B coloring agents in a first inkjet printer; providing a transparent coloring agent and filling it in a second inkjet printer, and causing the second inkjet printer to jet the transparent coloring agent on the printing surface of the printing board to form a protective layer; causing the first inkjet printer to jet the C/M/Y/B coloring agents on the protective layer to form a color image layer, such that the protective layer is located between the printing surface of the printing board and the color image layer; transferring the color image layer and the protective layer from the printing surface onto the pressure bearing surface of the rubber pad, such that the color image layer is located between the pressure bearing surface of the rubber pad and the protective layer; pressing the rubber pad against an outer surface of a convex mold, so that the protective layer and the color image layer are sequentially transferred from the rubber pad onto the outer surface of the convex mold; injecting a lens material into a concave mold; pressing the convex mold against the concave mold to form a lens layer on a surface of the color image layer; subjecting the color image layer, the protective layer and the lens layer to a curing process to form a color contact lens; waiting until the concave and the convex mold are cooled and then removing the color contact lens from the two molds; and subjecting the color contact lens to a hydration process.

The method of manufacturing color contact lens according to a ninth preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, providing a printing board formed of a thermoplastic elastomeric film and a phenol formaldehyde resin plate and having a printing surface, and filling C/M/Y/B coloring agents in a first inkjet printer; causing the first inkjet printer to jet the C/M/Y/B coloring agents on the printing surface of the printing board to form a color image layer; transferring the color image layer from the printing surface of the printing board onto the pressure bearing surface of the rubber pad; providing a transparent coloring agent and filling it in a second inkjet printer, and causing the second inkjet printer to jet the transparent coloring agent on the color image layer to form a protective layer, such that the color image layer is located between the pressure bearing surface of the rubber pad and the protective layer; pressing the rubber pad against an inner surface of a concave mold, so that the protective layer and the color image layer are sequentially transferred from the rubber pad onto the inner surface of the concave mold; injecting a lens material into the concave mold; pressing a convex mold against the concave mold to form a lens layer on a surface of the color image layer; subjecting the color image layer, the protective layer and the lens layer to a curing process to form a color contact lens; waiting until the concave and the convex mold are cooled and then removing the color contact lens from the two molds; and subjecting the color contact lens to a hydration process.

The method of manufacturing color contact lens according to a tenth preferred embodiment of the present invention includes the steps of mixing an amount of silicone rubber resin and an amount of silicone oil with an amount of curing agent and well stirring the mixture to provide a hybrid silicone rubber material; subjecting the hybrid silicone rubber material to a vacuum process; pouring the hybrid silicone rubber material into a forming mold; allowing the hybrid silicone rubber material to cure and form a rubber pad; providing the rubber pad that has an end forming a pressure bearing surface, providing a printing board formed of a thermoplastic elastomeric film and a phenol formaldehyde resin plate and having a printing surface, and filling C/M/Y/B coloring agents in a first inkjet printer; causing the first inkjet printer to jet the C/M/Y/B coloring agents on the printing surface of the printing board to form a color image layer; transferring the color image layer from the printing surface of the printing board onto the pressure bearing surface of the rubber pad; providing a transparent coloring agent and filling it in a second inkjet printer, and causing the second inkjet printer to jet the transparent coloring agent on the color image layer to form a protective layer, such that the color image layer is located between the pressure bearing surface of the rubber pad and the protective layer; pressing the rubber pad against an outer surface of a convex mold, so that the protective layer and the color image layer are sequentially transferred from the rubber pad onto the outer surface of the concave mold; injecting a lens material into a concave mold; pressing the convex mold against the concave mold to form a lens layer on a surface of the color image layer; subjecting the color image layer, the protective layer and the lens layer to a curing process to form a color contact lens; waiting until the concave and the convex mold are cooled and then removing the color contact lens from the two molds; and subjecting the color contact lens to a hydration process.

The method according to the present invention is characterized in that it can be used to handle any fine color pattern designed with computer-aided design (CAD) software for manufacturing a color contact lens. By causing the first inkjet printer to jet the C/M/Y/B coloring agents corresponding to the predetermined color pattern to form a color image layer on the printing surface of the printing board, transferring the color image layer onto the pressure bearing surface of the rubber pad, and pressing the rubber pad against a predetermined mold surface, it is able to quickly complete a multicolor pattern for a contact lens in one operation without increasing the thickness of the completed color image layer, and a lot of manufacturing cost and time is saved. When a large number of rubber pads and printing boards are provided, the first inkjet printer can also be used to jet the C/M/Y/B coloring agents on all the printing boards at the same time, and the color image layers on the printing boards are then simultaneously transferred onto the rubber pads. In this manner, the color contact lens can be mass-produced at reduced manufacturing cost to have good competitiveness in the market.

The method of manufacturing color contact lens according to the present invention can also be implemented on separate production lines. Therefore, after the first inkjet printer jets the C/M/Y/B coloring agents on the printing surface of the printing board to form the color image layer, the color image layer on the printing surface of the printing board can be compared with the color pattern shown on the computer to check the color image layer for its integrity, so as to reduce the defect rate of the finished color contact lenses.

Further, by causing the second inkjet printer to jet the transparent coloring agent on the printing surface of the printing board to form the protective layer, causing the first inkjet printer to jet the C/M/Y/B coloring agents on the surface of the protective layer to form the color image layer, transferring the protective layer and the color image layer onto the pressure bearing surface of the rubber pad, pressing the rubber pad against the concave mold to transfer the color image layer and the protective layer onto the inner surface of the concave mold, injecting the lens material into the concave mold, and pressing the convex mold against the concave mold to form the lens layer, the color image layer is located between the lens layer and the protective layer to form the color contact lens. In this manner, all the colors of the color image layer can be completely shown without the risk of peeling off easily. Further, since the pigments of the color image layer are not in direct contact with the wearer's cornea, the color contact lens is more comfortable and safer for wearing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a conventional method of manufacturing color contact lens;

FIG. 2 is a pictorial description of the steps in the flowchart of FIG. 1;

FIG. 3 is a flowchart showing the steps included in a method of manufacturing color contact lens according to a first preferred embodiment of the present invention;

FIG. 4 is a pictorial description of the steps in a first part of the flowchart of FIG. 3;

FIG. 5 is a pictorial description of the steps in a second part of the flowchart of FIG. 3;

FIG. 6 is a flowchart showing the steps included in a method of manufacturing color contact lens according to a second preferred embodiment of the present invention;

FIG. 7 is a pictorial description of the steps in a first part of the flowchart of FIG. 6;

FIG. 8 is a pictorial description of the steps in a second part of the flowchart of FIG. 6;

FIG. 9 is a flowchart showing the steps included in a method of manufacturing color contact lens according to a third preferred embodiment of the present invention;

FIG. 10 is a pictorial description of the steps in a first part of the flowchart of FIG. 9;

FIG. 11 is a pictorial description of the steps in a second part of the flowchart of FIG. 9;

FIG. 12 is a pictorial description of the steps in a third part of the flowchart of FIG. 9;

FIG. 13 is a flowchart showing the steps included in a method of manufacturing color contact lens according to a fourth preferred embodiment of the present invention;

FIG. 14 is a pictorial description of the steps in a first part of the flowchart of FIG. 13;

FIG. 15 is a pictorial description of the steps in a second part of the flowchart of FIG. 13;

FIG. 16 is a pictorial description of the steps in a third part of the flowchart of FIG. 13;

FIG. 17 is a flowchart showing the steps included in a method of manufacturing color contact lens according to a fifth preferred embodiment of the present invention;

FIG. 18 is a pictorial description of the steps in a first part of the flowchart of FIG. 17;

FIG. 19 is a pictorial description of the steps in a second part of the flowchart of FIG. 17;

FIG. 20 is a flowchart showing the steps included in a method of manufacturing color contact lens according to a sixth preferred embodiment of the present invention;

FIG. 21 is a pictorial description of the steps in a first part of the flowchart of FIG. 20;

FIG. 22 is a pictorial description of the steps in a second part of the flowchart of FIG. 20;

FIGS. 23 and 24 are a flowchart showing the steps included in a method of manufacturing color contact lens according to a seventh preferred embodiment of the present invention;

FIG. 25 is a pictorial description of the steps in a first part of the flowchart of FIGS. 23 and 24;

FIG. 26 is a pictorial description of the steps in a second part of the flowchart of FIGS. 23 and 24;

FIG. 27 is a pictorial description of the steps in a third part of the flowchart of FIGS. 23 and 24;

FIGS. 28 and 29 are a flowchart showing the steps included in a method of manufacturing color contact lens according to an eighth preferred embodiment of the present invention;

FIG. 30 is a pictorial description of the steps in a first part of the flowchart of FIGS. 28 and 29;

FIG. 31 is a pictorial description of the steps in a second part of the flowchart of FIGS. 28 and 29;

FIG. 32 is a pictorial description of the steps in a third part of the flowchart of FIGS. 28 and 29;

FIGS. 33 and 34 are a flowchart showing the steps included in a method of manufacturing color contact lens according to a ninth preferred embodiment of the present invention;

FIG. 35 is a pictorial description of the steps in a first part of the flowchart of FIGS. 33 and 34;

FIG. 36 is a pictorial description of the steps in a second part of the flowchart of FIGS. 33 and 34;

FIG. 37 is a pictorial description of the steps in a third part of the flowchart of FIGS. 33 and 34;

FIGS. 38 and 39 are a flowchart showing the steps included in a method of manufacturing color contact lens according to a tenth preferred embodiment of the present invention;

FIG. 40 is a pictorial description of the steps in a first part of the flowchart of FIGS. 38 and 39;

FIG. 41 is a pictorial description of the steps in a second part of the flowchart of FIGS. 38 and 39; and

FIG. 42 is a pictorial description of the steps in a third part of the flowchart of FIGS. 38 and 39.

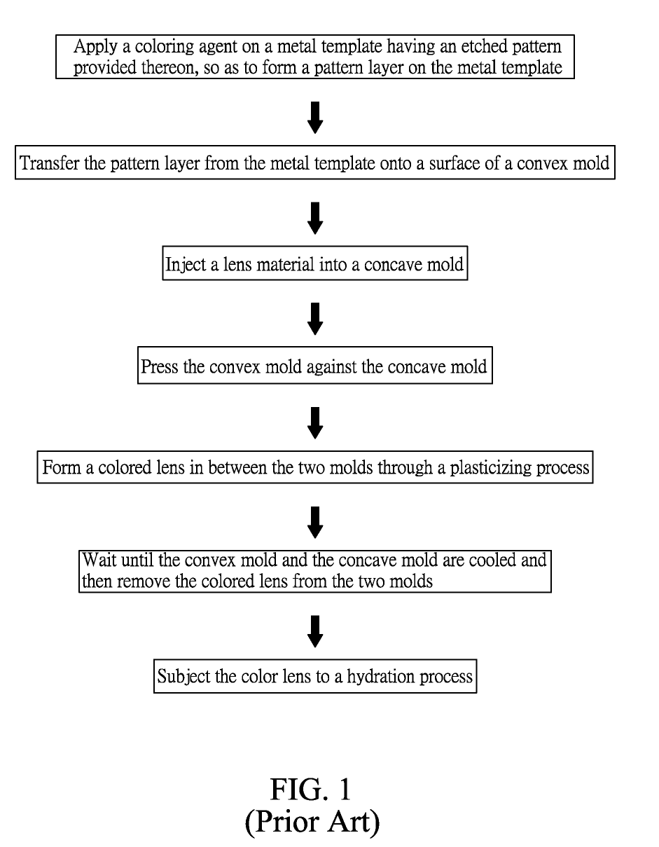

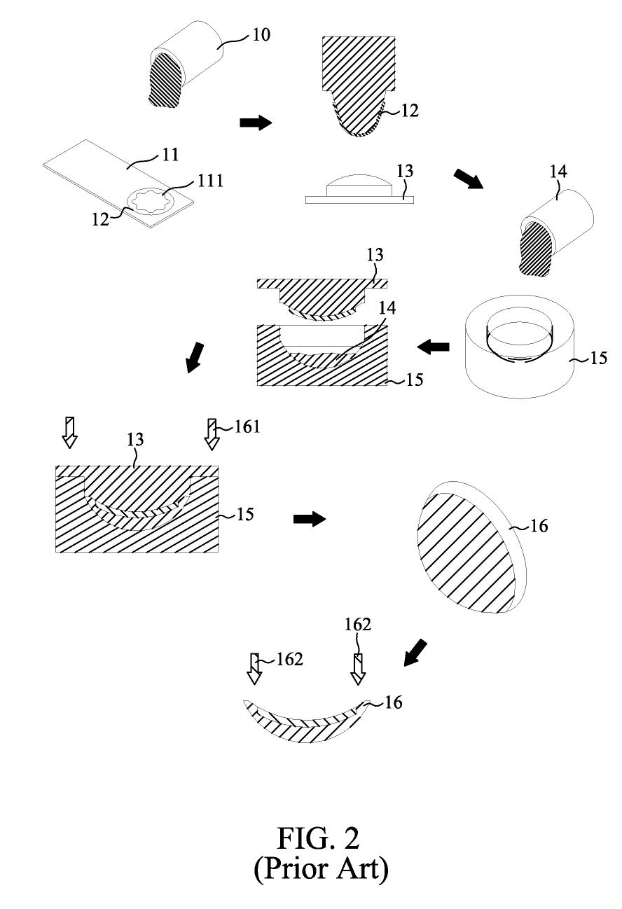

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

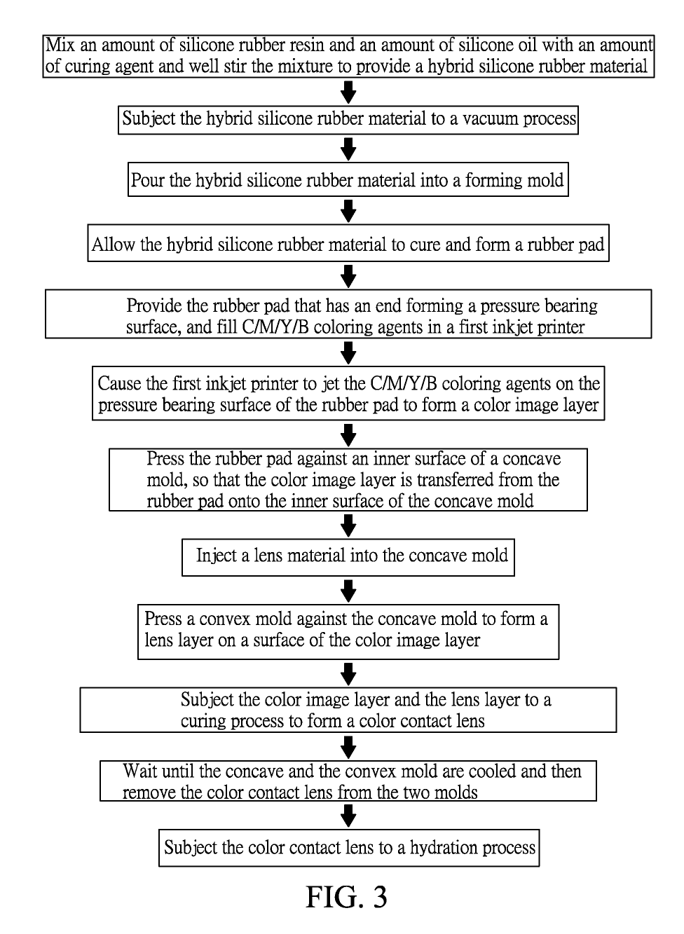

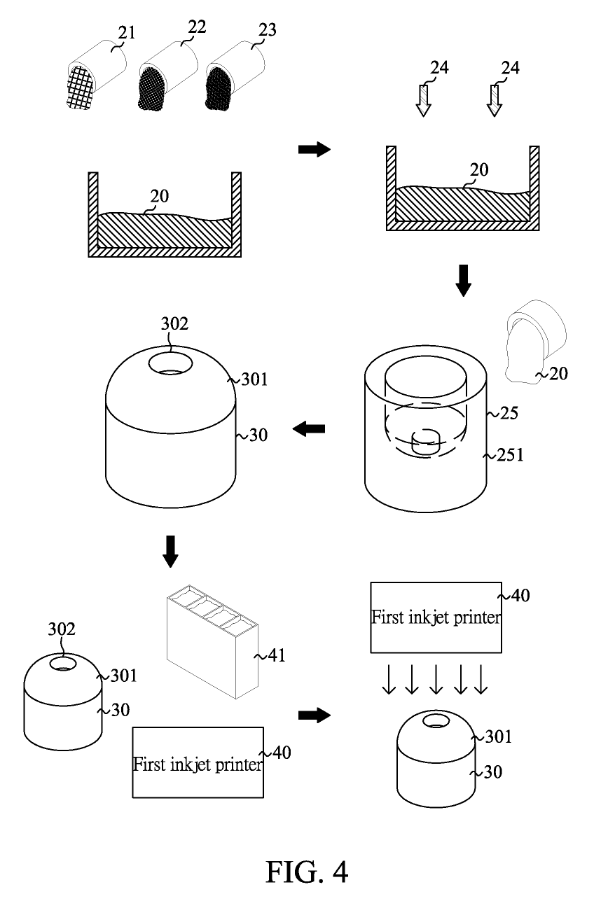

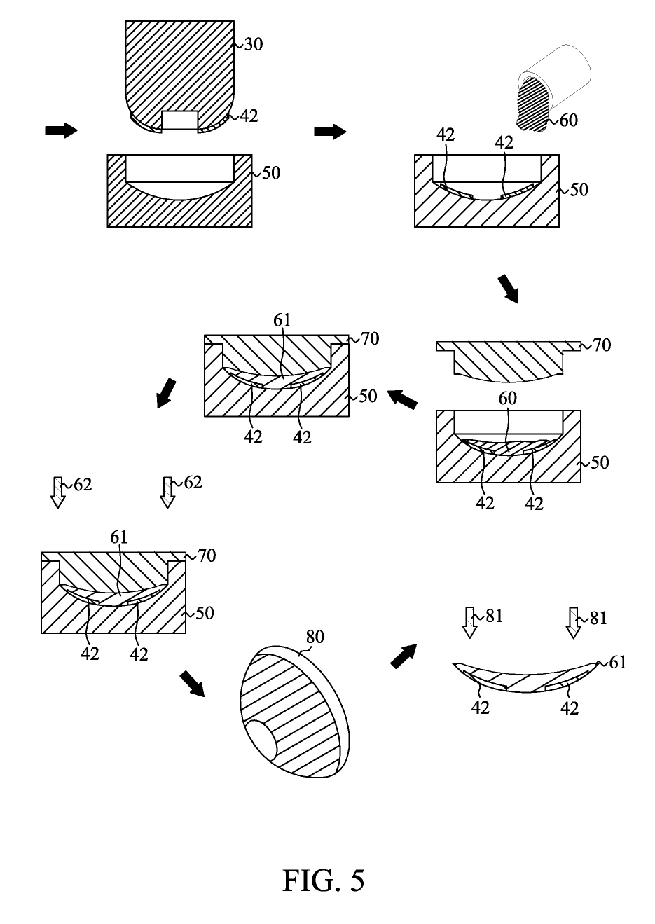

Please refer to FIG. 3 that is a flowchart showing the steps included in a method of manufacturing color contact lens according to a first preferred embodiment of the present invention, and to FIGS. 4 and 5 that are pictorial descriptions of the steps in the flowchart of FIG. 3. The following is a detailed description of these steps, which are numbered from (a) to (l) herein for ease of reference.

Step (a): Mix an amount of silicone rubber resin 21 and an amount of silicone oil 22 with an amount of curing agent 23 and well stir the mixture to provide a hybrid silicone rubber material 20. In a preferred embodiment, the silicone rubber resin 21 and the silicone oil 22 are first evenly stirred, and the curing agent 23 is added to the mixture later to form the hybrid silicone rubber material 20.

Preferably, the silicone rubber resin 21, the silicone oil 22 and the curing agent 23 are respectively present in an amount of 65-75, 25-30 and 3-8 volume percent of the total hybrid silicone rubber material 20.

According to a preferred embodiment, the best amount ratio of the silicone rubber resin 21 to the silicone oil 22 is 100 g:40 g, while the amount of the curing agent 23 to be added changes according to the amount ratio of the silicone rubber resin 21 to the silicone oil 22. Generally, the amount of the curing agent 23 is controlled to be less than 5 volume percent of the total hybrid silicone rubber material 20.

Step (b): Subject the hybrid silicone rubber material 20 to a vacuum process 24. After the curing agent 23 is added, vapors would occur in the produced hybrid silicone rubber material 20. Since the hybrid silicone rubber material 20 is highly viscous, it tends to trap air during the process of stirring. To prevent air from being mixed therewith, the hybrid silicone rubber material 20 must be subjected to a vacuum process for about 1 to 3 minutes.

Step (c): Pour the hybrid silicone rubber material 20 into a forming mold 25. The forming mold 25 is made of a metal material or a plastic resin material. In the illustrated first preferred embodiment, the forming mold 25 is a crystal mold 251 made of a transparent unsaturated polyester resin material.

Step (d): Allow the hybrid silicone rubber material 20 to cure at an environment temperature of 25° C. for 8 hours, so as to form a rubber pad 30. As shown in FIG. 4, the rubber pad 30 has a pressure bearing surface 301, on a center of which a hollow opening 302 is formed. Further, the rubber pad 30 formed using the above-mentioned crystal mold 251 can have an improved quality.

However, the forming of the rubber pad 30 using a forming mold 25 is only illustrative and not intended to limit the way of forming the rubber pad 30 according to the present invention. That is, according to different demands, the rubber pad 30 can also be formed by way of fused deposition modeling using a rapid prototyping (RP) machine.

Step (e): Provide the rubber pad 30 having the pressure bearing surface 301 and fill C/M/Y/B coloring agents 41 in a first inkjet printer 40. The C/M/Y/B coloring agents 41 include four colors, namely, cyan, magenta, yellow and black colors, and the four coloring agents 41 are filled in four separate ink cartridges (not shown) of the first inkjet printer 40.

Step (f): Use CAD (computer-aided design) software to output a finished color pattern, and cause the first inkjet printer 40 to jet the C/M/Y/B coloring agents 41 corresponding to the color pattern to form a color image layer 42 on the pressure bearing surface 301 of the rubber pad 30. In this way, after the first inkjet printer 40 has jetted the C/M/Y/B coloring agents 41, the color image layer 42 formed on the pressure bearing surface 301 of the rubber pad 30 can be compared with the color pattern shown on the computer to check the color image layer for the integrity thereof, so as to lower the defect rate of the produced contact lens.

Step (g): Press the rubber pad 30 against an inner surface of a concave mold 50, so that the color image layer 42 is transferred from the rubber pad 30 onto the inner surface of the concave mold 50. When pressing the rubber pad 30 against the concave mold 50, the hollow opening 302 on the rubber pad 30 prevents a central area of the inner surface of the concave mold 50 from contacting with the color image layer 42. Further, in the process of pressing the rubber pad 30 against the concave mold 50, the hollow opening 302 of the rubber pad 30 also helps in venting air to thereby prevent air bubbles from forming between the color image layer 42 and the inner surface of the concave mold 50. In this way, the risk of having blurs or white spaces formed in the color image layer 42 can be reduced.

Step (h): Inject a lens material 60 into the concave mold 50. In the illustrated preferred embodiment, the lens material 60 is a hydroxyethyl methacrylate (HEMA) based hydrogel material.

Step (i): Press a convex mold 70 against the concave mold 50 to form a lens layer 61 on a surface of the color image layer 42.

Step (j): Subject the color image layer 42 and the lens layer 61 to a curing process 62 to form a color contact lens 80. In the curing process 62, the color image layer 42 and the lens layer 61 are exposed to heat radiation, ultraviolet (UV) radiation, microwave radiation or ionizing radiation, so that the color image layer 42 and the lens layer 61 are cured to form the color contact lens 80.

Step (k): Wait until the concave mold 50 and the convex mold 70 are cooled, and then remove the color contact lens 80 from the two molds. When the concave mold 50 and the convex mold 70 are pressed against each other, they will have a raised temperature. Therefore, wait until the two molds 50, 70 are cooled and then remove the color contact 80 from the two molds.

Step (l): Subject the color contact lens 80 to a hydration process 81. In the hydration process 81, the color contact lens 80 is immersed in pure water to absorb water and becomes softened. The softened color contact lens 80 won't cause discomfort to a wearer's eyes.

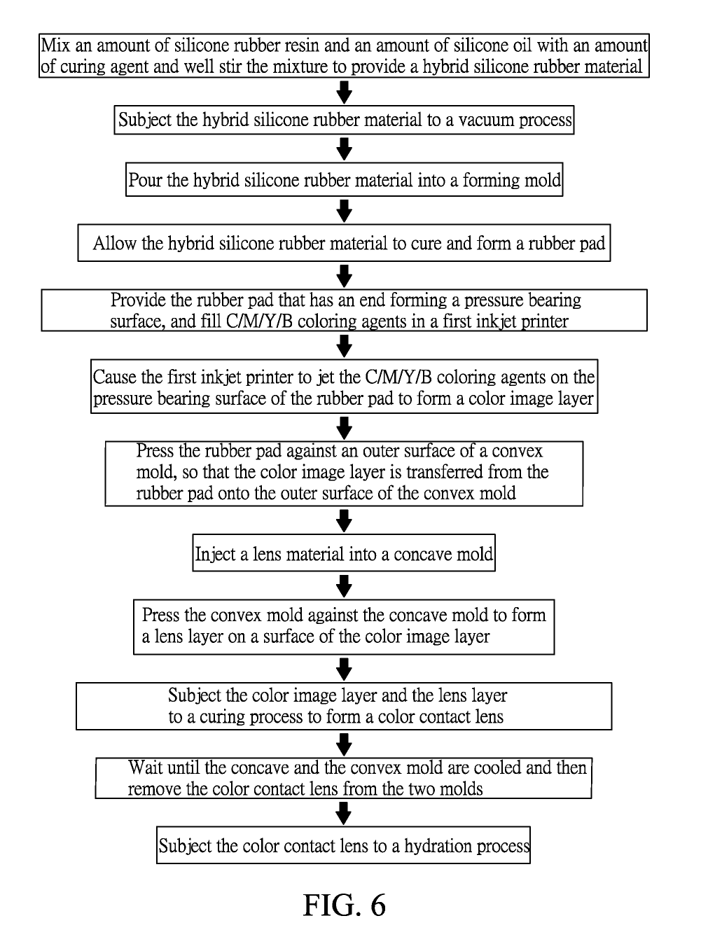

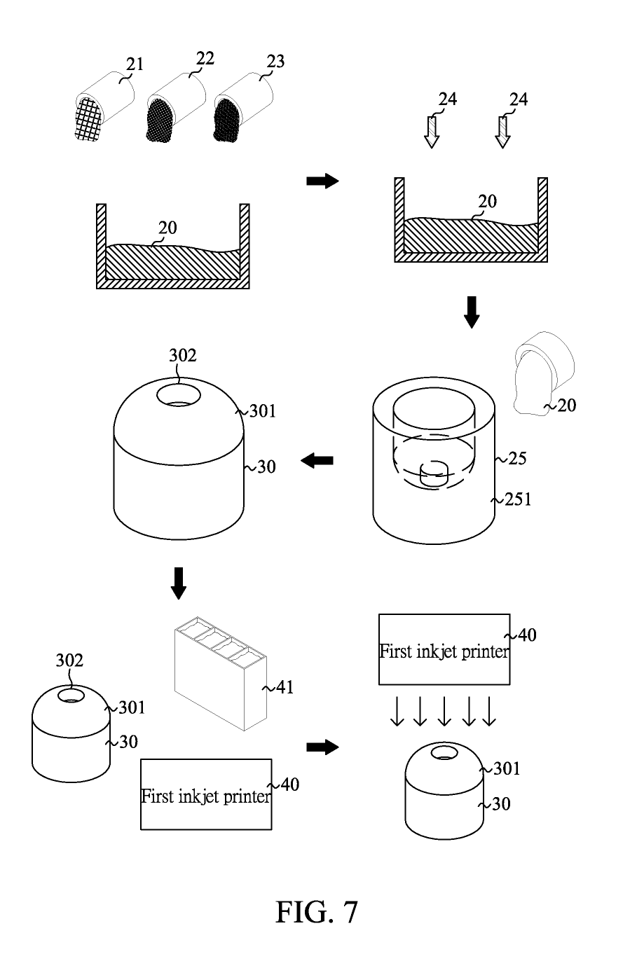

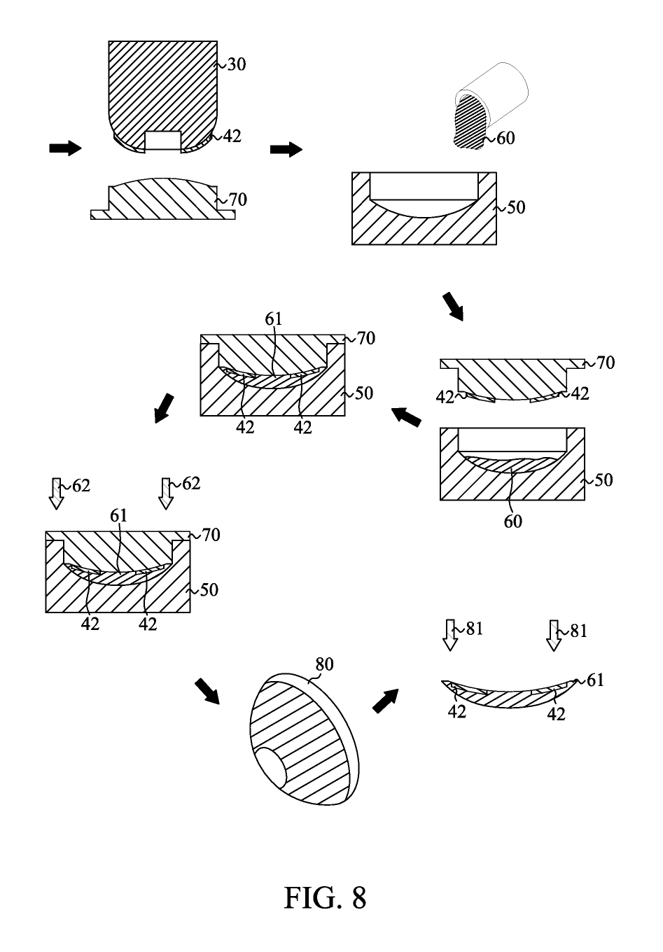

Please refer to FIG. 6 that is a flowchart showing the steps included in a method of manufacturing color contact lens according to a second preferred embodiment of the present invention, and to FIGS. 7 and 8 that are pictorial descriptions of the steps in the flowchart of FIG. 6. The following is a detailed description of the steps in the second preferred embodiment, which are numbered from (a) to (h) herein for ease of reference.

Step (a): Provide a rubber pad 30 and fill C/M/Y/B coloring agents 41 in a first inkjet printer 40. The rubber pad 30 is manufactured and shaped in the same manner as described in the first preferred embodiment and is therefore not repeatedly described herein.

Step (b): Cause the first inkjet printer 40 to jet the C/M/Y/B coloring agents 41 corresponding to a color pattern on a computer to form a color image layer 42 on a pressure bearing surface 301 of the rubber pad 30. The C/M/Y/B coloring agents 41 include four colors, namely, cyan, magenta, yellow and black colors, and the four coloring agents 41 are filled in four separate ink cartridges (not shown) of the first inkjet printer 40.

After the first inkjet printer 40 has jetted the C/M/Y/B coloring agents 41, the color image layer 42 formed on the pressure bearing surface 301 of the rubber pad 30 can be compared with the color pattern shown on the computer to check the color image layer for the integrity thereof, so as to lower the defect rate of the produced contact lens.

Step (c): Press the rubber pad 30 against an outer surface of a convex mold 70, so that the color image layer 42 is transferred from the rubber pad 30 onto the outer surface of the convex mold 70. When pressing the rubber pad 30 against the convex mold 70, the hollow opening 302 on the rubber pad 30 prevents a central area of the outer surface of the convex mold 70 from contacting with the color image layer 42. Further, in the process of pressing the rubber pad 30 against the convex mold 70, the hollow opening 302 of the rubber pad 30 also helps in venting air to thereby prevent air bubbles from forming between the color image layer 42 and the outer surface of the convex mold 70. In this way, the risk of having blurs or white spaces formed in the color image layer 42 can be reduced.

Step (d): Inject a lens material 60 into a concave mold 50. In the illustrated preferred embodiment, the lens material 60 is a hydroxyethyl methacrylate (HEMA) based hydrogel material.

Step (e): Press the convex mold 70 against the concave mold 50 to form a lens layer 61 on a surface of the color image layer 42.

Step (f): Subject the color image layer 42 and the lens layer 61 to a curing process 62 to form a color contact lens 80. In the curing process 62, the color image layer 42 and the lens layer 61 are exposed to heat radiation, ultraviolet (UV) radiation, microwave radiation or ionizing radiation, so that the color image layer 42 and the lens layer 61 are cured to form the color contact lens 80.

Step (g): Wait until the concave mold 50 and the convex mold 70 are cooled, and then remove the color contact lens 80 from the molds. When the concave mold 50 and the convex mold 70 are pressed against each other, they will have a raised temperature. Therefore, wait until the two molds 50, 70 are cooled and then remove the color contact 80 from the molds.

Step (h): Subject the color contact lens 80 to a hydration process 81. In the hydration process 81, the color contact lens 80 is immersed in pure water to absorb water and becomes softened. The softened color contact lens 80 won't cause discomfort to a wearer's eyes.

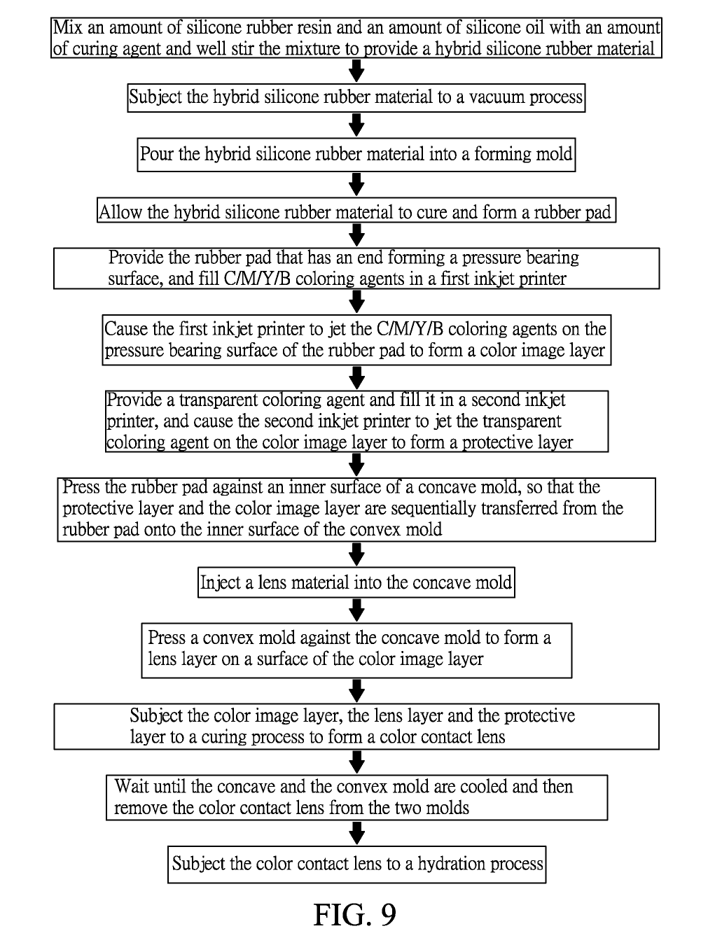

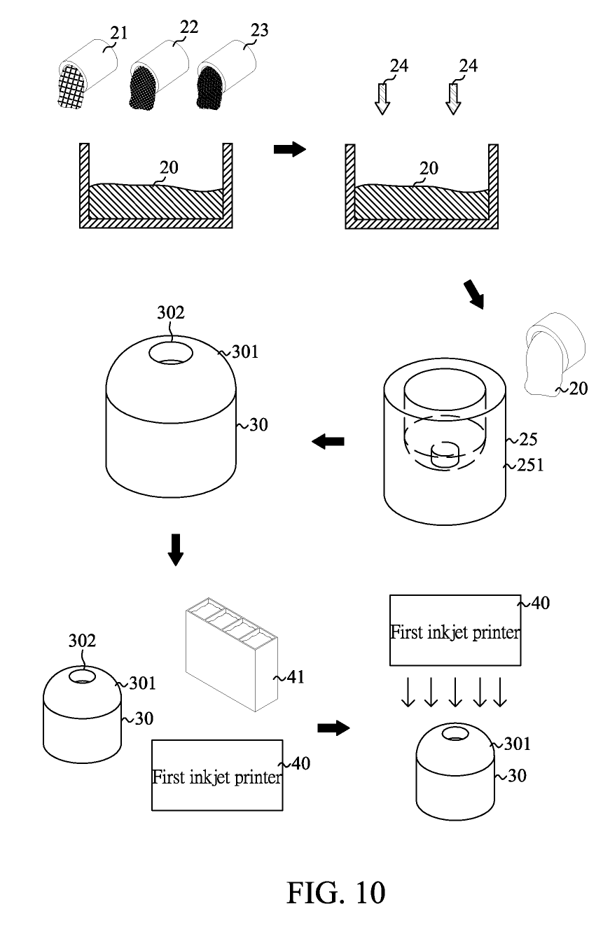

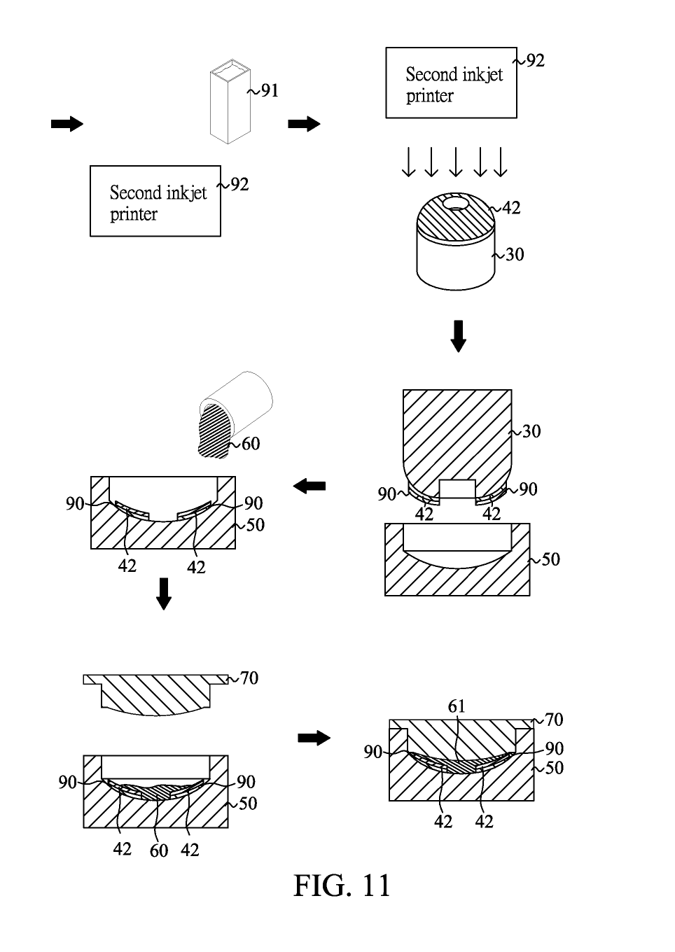

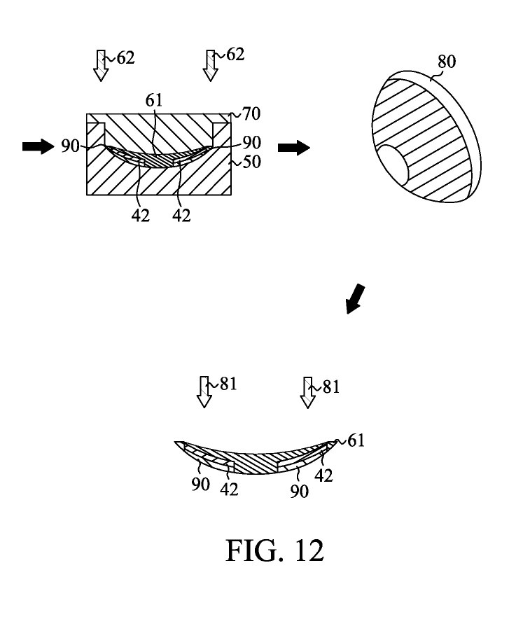

Please refer to FIG. 9 that is a flowchart showing the steps included in a method of manufacturing color contact lens according to a third preferred embodiment of the present invention, and to FIGS. 10 to 12 that are pictorial descriptions of the steps in the flowchart of FIG. 9. The third preferred embodiment is different from the first preferred embodiment in that the color contact lens 80 manufactured according to the steps of the third preferred embodiment further includes a protective layer 90. The following is a detailed description of the steps in the third preferred embodiment, which are numbered from (a) to (i) herein for ease of reference.

Step (a): Provide a rubber pad 30 and fill C/M/Y/B coloring agents 41 in a first inkjet printer 40. The rubber pad 30 is manufactured and shaped in the same manner as described in the first preferred embodiment and is therefore not repeatedly described herein.

Step (b): Cause the first inkjet printer 40 to jet the C/M/Y/B coloring agents 41 corresponding to a color pattern on a computer to form a color image layer 42 on a pressure bearing surface 301 of the rubber pad 30. The C/M/Y/B coloring agents 41 include four colors, namely, cyan, magenta, yellow and black colors, and the four coloring agents 41 are filled in four separate ink cartridges (not shown) of the first inkjet printer 40.

After the first inkjet printer 40 has jetted the C/M/Y/B coloring agents 41, the color image layer 42 formed on the pressure bearing surface 301 of the rubber pad 30 can be compared with the color pattern shown on the computer to check the color image layer for the integrity thereof, so as to lower the defect rate of the contact lens.

Step (c): Provide a transparent coloring agent 91 and fill it in a second inkjet printer 92, and cause the second inkjet printer 92 to jet the transparent coloring agent 91 on a surface of the color image layer 42 to form a protective layer 90.

Step (d): Press the rubber pad 30 against an inner surface of a concave mold 50, so that the protective layer 90 and the color image layer 42 are sequentially transferred from the rubber pad 30 onto the inner surface of the concave mold 50. When pressing the rubber pad 30 against the concave mold 50, the hollow opening 302 on the rubber pad 30 prevents a central area of the inner surface of the concave mold 50 from contacting with the color image layer 42. Further, in the process of pressing the rubber pad 30 against the concave mold 50, the hollow opening 302 of the rubber pad 30 also helps in venting air to thereby prevent air bubbles from forming between the color image layer 42 and the inner surface of the concave mold 50. In this way, the risk of having blurs or white spaces formed in the color image layer 42 can be reduced.

Step (e): Inject a lens material 60 into the concave mold 50. In the illustrated preferred embodiment, the lens material 60 is a hydroxyethyl methacrylate (HEMA) based hydrogel material.

Step (f): Press a convex mold 70 against the concave mold 50 to form a lens layer 61 on a surface of the color image layer 42. In this manner, the color image layer 42 is located between the protective layer 90 and the lens layer 61, such that all the colors of the color image layer 42 can be completely shown without the risk of peeling off easily. Further, since the pigments of the color image layer 42 are not in direct contact with the wearer's cornea, the contact lens is more comfortable for wearing.

Step (g): Subject the color image layer 42, the lens layer 61 and the protective layer 90 to a curing process 62 to form a color contact lens 80. In the curing process 62, the color image layer 42, the lens layer 61 and the protective layer 90 are exposed to heat radiation, ultraviolet (UV) radiation, microwave radiation or ionizing radiation, so that they are cured to form the color contact lens 80.

Step (h): Wait until the concave mold 50 and the convex mold 70 are cooled, and then remove the color contact lens 80 from the molds. When the concave mold 50 and the convex mold 70 are pressed against each other, they will have a raised temperature. Therefore, wait until the two molds 50, 70 are cooled and then remove the color contact 80 from the molds.

Step (i): Subject the color contact lens 80 to a hydration process 81. In the hydration process 81, the color contact lens 80 is immersed in pure water to absorb water and becomes softened. The softened color contact lens 80 won't cause discomfort to a wearer's eyes.

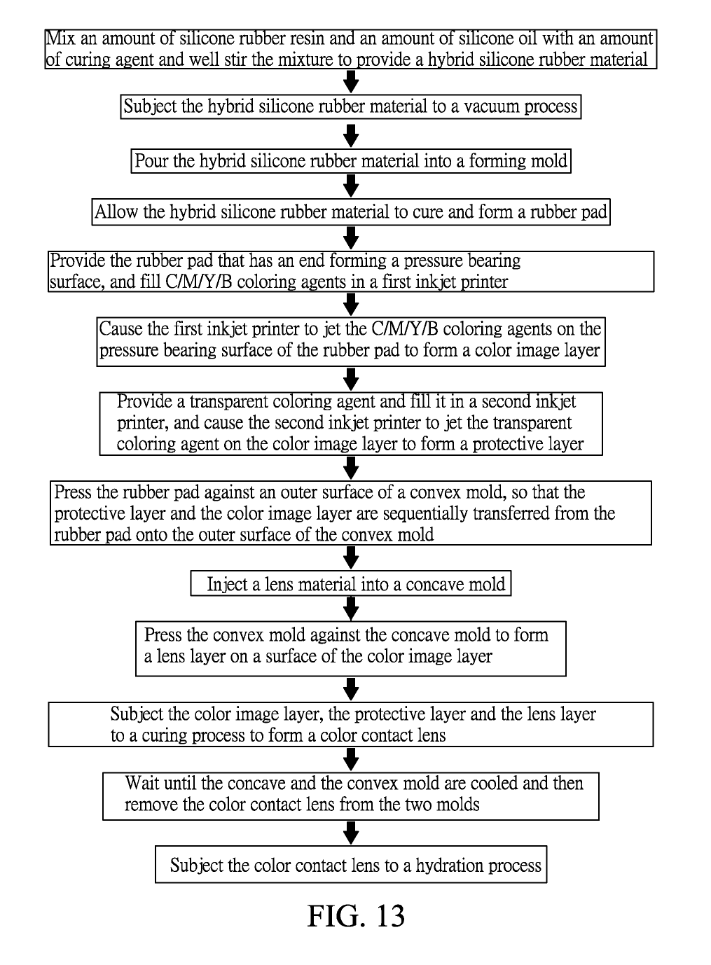

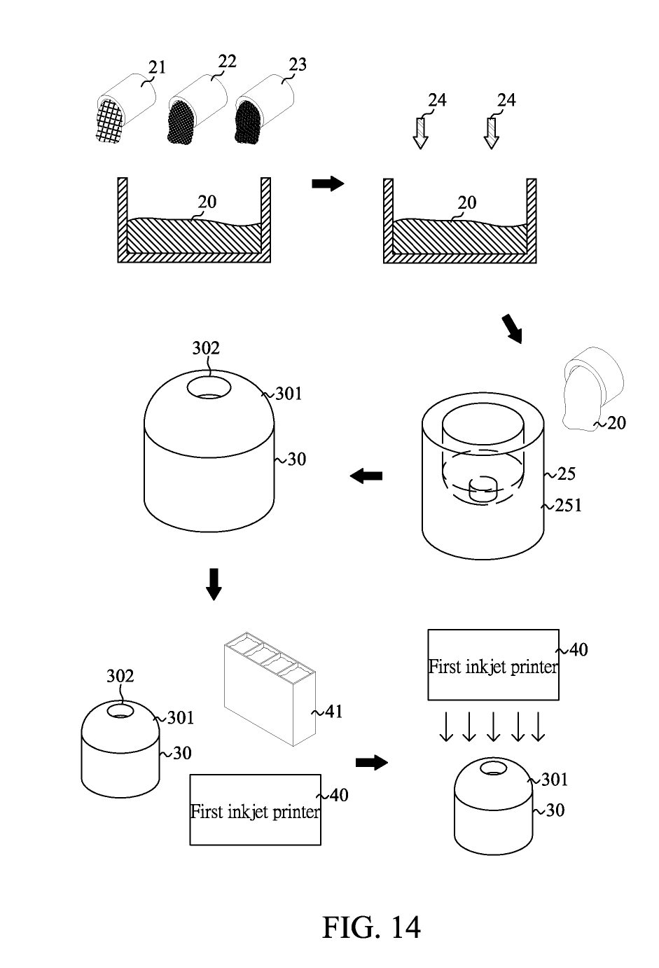

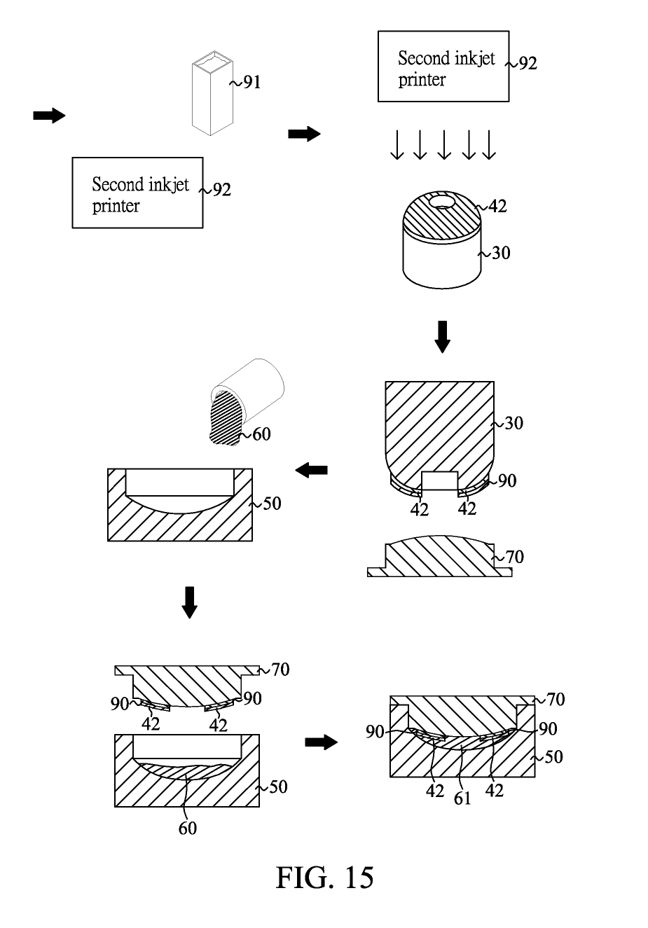

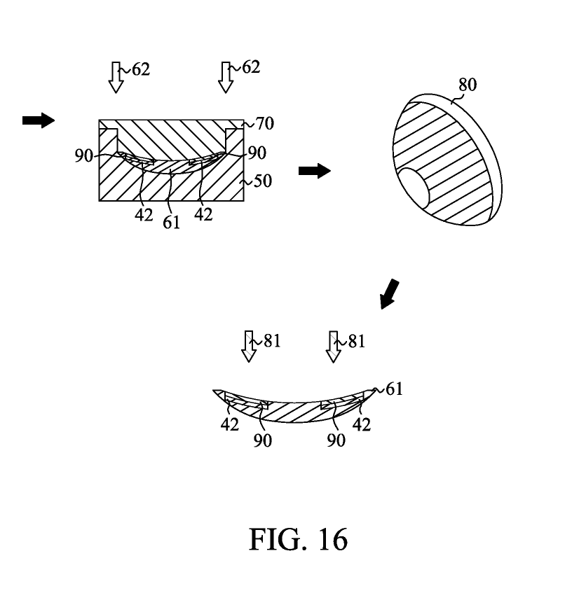

Please refer to FIG. 13 that is a flowchart showing the steps included in a method of manufacturing color contact lens according to a fourth preferred embodiment of the present invention, and to FIGS. 14 to 16 that are pictorial descriptions of the steps in the flowchart of FIG. 13. The fourth preferred embodiment is different from the second preferred embodiment in that the color contact lens 80 manufactured according to the steps of the fourth preferred embodiment further includes a protective layer 90. The following is a detailed description of the steps in the fourth preferred embodiment, which are numbered from (a) to (i) herein for ease of reference.

Step (a): Provide a rubber pad 30 and fill C/M/Y/B coloring agents 41 in a first inkjet printer 40. The rubber pad 30 is manufactured and shaped in the same manner as described in the first preferred embodiment and is therefore not repeatedly described herein.

Step (b): Cause the first inkjet printer 40 to jet the C/M/Y/B coloring agents 41 corresponding to a color pattern on a computer to form a color image layer 42 on a pressure bearing surface 301 of the rubber pad 30. The C/M/Y/B coloring agents 41 include four colors, namely, cyan, magenta, yellow and black colors, and the four coloring agents 41 are filled in four separate ink cartridges (not shown) of the first inkjet printer 40.

After the first inkjet printer 40 has jetted the C/M/Y/B coloring agents 41, the color image layer 42 formed on the pressure bearing surface 301 of the rubber pad 30 can be compared with the color pattern shown on the computer to check the color image layer for the integrity thereof, so as to lower the defect rate of the produced contact lens.

Step (c): Provide a transparent coloring agent 91 and fill it in a second inkjet printer 92, and cause the second inkjet printer 92 to jet the transparent coloring agent 91 on a surface of the color image layer 42 to form a protective layer 90.

Step (d): Press the rubber pad 30 against an outer surface of a convex mold 70, so that the protective layer 90 and the color image layer 42 are sequentially transferred from the rubber pad 30 onto the outer surface of the convex mold 70. When pressing the rubber pad 30 against the convex mold 70, the hollow opening 302 on the rubber pad 30 prevents a central area of the outer surface of the convex mold 70 from contacting with the color image layer 42. Further, in the process of pressing the rubber pad 30 against the convex mold 70, the hollow opening 302 of the rubber pad 30 also helps in venting air to thereby prevent air bubbles from forming between the color image layer 42 and the outer surface of the convex mold 70. In this way, the risk of having blurs or white spaces formed in the color image layer 42 can be reduced.

Step (e): Inject a lens material 60 into a concave mold 50. In the illustrated preferred embodiment, the lens material 60 is a hydroxyethyl methacrylate (HEMA) based hydrogel material.

Step (f): Press the convex mold 70 against the concave mold 50 to form a lens layer 61 on a surface of the color image layer 42. In this manner, the color image layer 42 is located between the protective layer 90 and the lens layer 61, such that all the colors of the color image layer 42 can be completely shown without the risk of peeling off easily. Further, since the pigments of the color image layer 42 are not in direct contact with the wearer's cornea, the contact lens is more comfortable for wearing.

Step (g): Subject the color image layer 42, the lens layer 61 and the protective layer 90 to a curing process 62 to form a color contact lens 80. In the curing process 62, the color image layer 42, the lens layer 61 and the protective layer 90 are exposed to heat radiation, ultraviolet (UV) radiation, microwave radiation or ionizing radiation, so that they are cured to form the color contact lens 80.

Step (h): Wait until the concave mold 50 and the convex mold 70 are cooled, and then remove the color contact lens 80 from the molds. When the concave mold 50 and the convex mold 70 are pressed against each other, they will have a raised temperature. Therefore, wait until the two molds 50, 70 are cooled and then remove the color contact 80 from the molds.

Step (i): Subject the color contact lens 80 to a hydration process 81. In the hydration process 81, the color contact lens 80 is immersed in pure water to absorb water and becomes softened. The softened color contact lens 80 won't cause discomfort to a wearer's eyes.

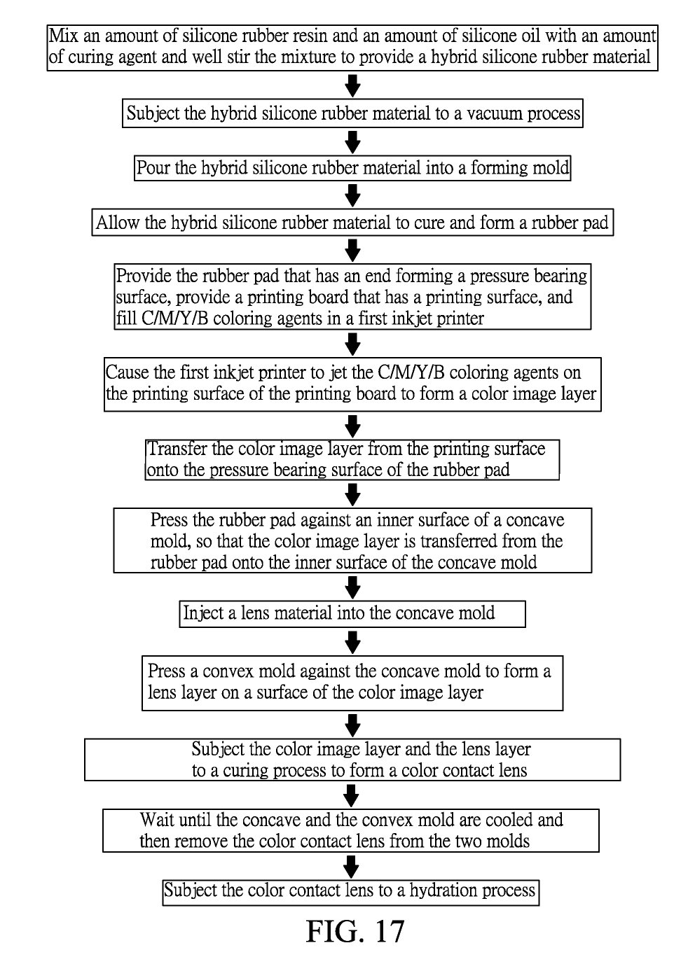

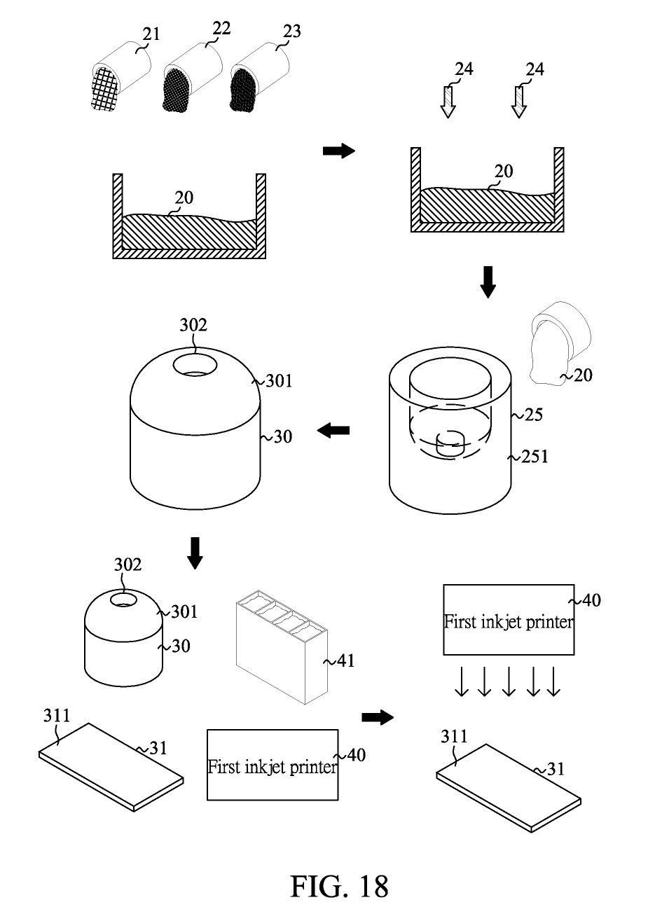

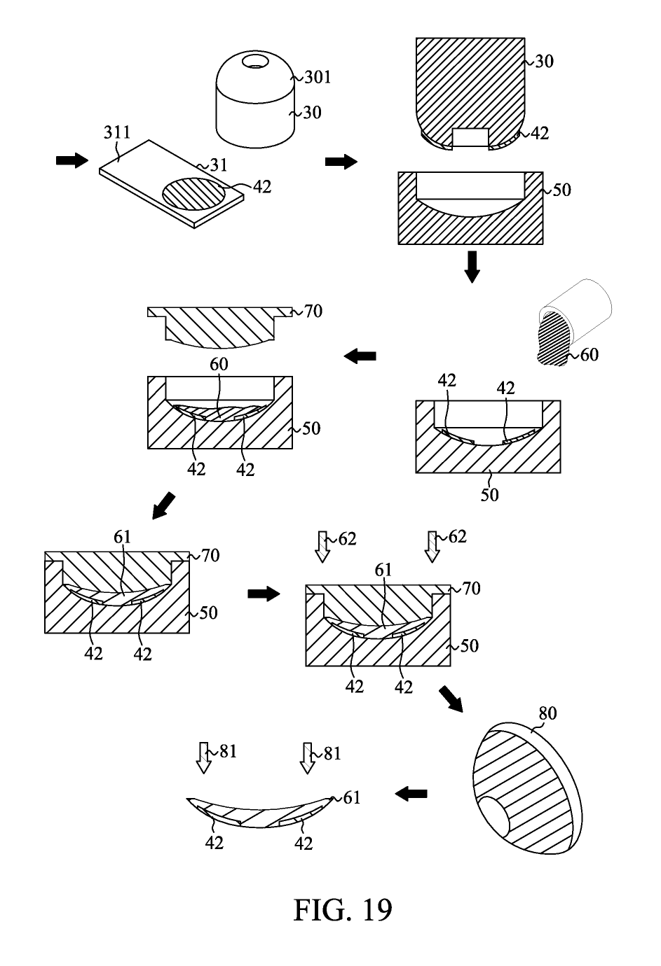

Please refer to FIG. 17 that is a flowchart showing the steps included in a method of manufacturing color contact lens according to a fifth preferred embodiment of the present invention, and to FIGS. 18 and 19 that are pictorial descriptions of the steps in the flowchart of FIG. 17. The following is a detailed description of the steps in the fifth preferred embodiment, which are numbered from (a) to (j) herein for ease of reference.

Step (a): Provide a rubber pad 30 having a pressure bearing surface 301. The rubber pad 30 is manufactured and shaped in the same manner as described in the first preferred embodiment and is therefore not repeatedly described herein.

Step (b): Provide a printing board 31 having a printing surface 311 and fill C/M/Y/B coloring agents 41 in a first inkjet printer 40. The C/M/Y/B coloring agents 41 include four colors, namely, cyan, magenta, yellow and black colors, and the four coloring agents 41 are filled in four separate ink cartridges (not shown) of the first inkjet printer 40.

In the fifth preferred embodiment, the printing board 31 includes a thermoplastic elastomeric film 312 and a phenol formaldehyde resin plate 313, which are engaging with, gluing to or binding to each other to form the printing board 31.

Step (c): Use CAD software to output a finished color pattern, and cause the first inkjet printer 40 to jet the C/M/Y/B coloring agents 41 corresponding to the color pattern to form a color image layer 42 on the printing surface 311 of the printing board 31. In this way, after the first inkjet printer 40 has jetted the C/M/Y/B coloring agents 41, the color image layer 42 formed on the printing surface 311 of the printing board 31 can be compared with the color pattern shown on the computer to check the color image layer 42 for the integrity thereof, so as to lower the defect rate of the produced contact lens.

Step (d): Transfer the color image layer 42 from the printing surface 311 onto the pressure bearing surface 301 of the rubber pad 30.

Step (e): Press the rubber pad 30 against an inner surface of a concave mold 50, so that the color image layer 42 is transferred from the rubber pad 30 onto the inner surface of the concave mold 50. When pressing the rubber pad 30 against the concave mold 50, the hollow opening 302 on the rubber pad 30 prevents a central area of the inner surface of the concave mold 50 from contacting with the color image layer 42. Further, in the process of pressing the rubber pad 30 against the concave mold 50, the hollow opening 302 of the rubber pad 30 also helps in venting air to thereby prevent air bubbles from forming between the color image layer 42 and the inner surface of the concave mold 50. In this way, the risk of having blurs or white spaces formed in the color image layer 42 can be reduced.

Step (f): Inject a lens material 60 into the concave mold 50. In the illustrated preferred embodiment, the lens material 60 is a hydroxyethyl methacrylate (HEMA) based hydrogel material.

Step (g): Press a convex mold 70 against the concave mold 50 to form a lens layer 61 on a surface of the color image layer 42.

Step (h): Subject the color image layer 42 and the lens layer 61 to a curing process 62 to form a color contact lens 80. In the curing process 62, the color image layer 42 and the lens layer 61 are exposed to heat radiation, ultraviolet (UV) radiation, microwave radiation or ionizing radiation, so that the color image layer 42 and the lens layer 61 are cured to form the color contact lens 80.

Step (i): Wait until the concave mold 50 and the convex mold 70 are cooled, and then remove the color contact lens 80 from the molds. When the concave mold 50 and the convex mold 70 are pressed against each other, they will have a raised temperature. Therefore, wait until the two molds 50, 70 are cooled and then remove the color contact 80 from the molds.

Step (j): Subject the color contact lens 80 to a hydration process 81. In the hydration process 81, the color contact lens 80 is immersed in pure water to absorb water and becomes softened. The softened color contact lens 80 won't cause discomfort to a wearer's eyes.

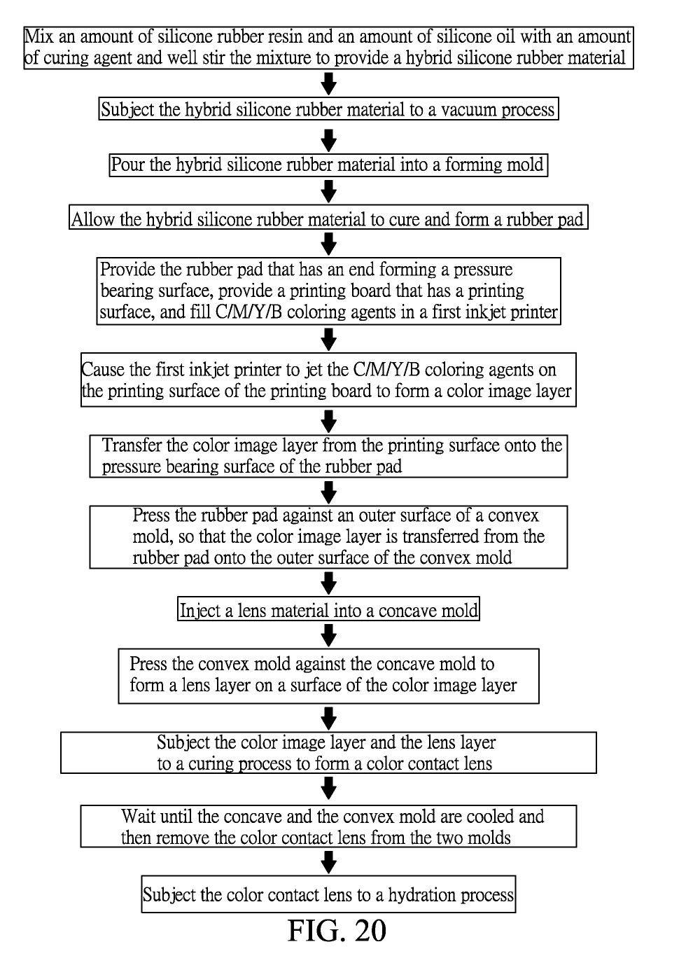

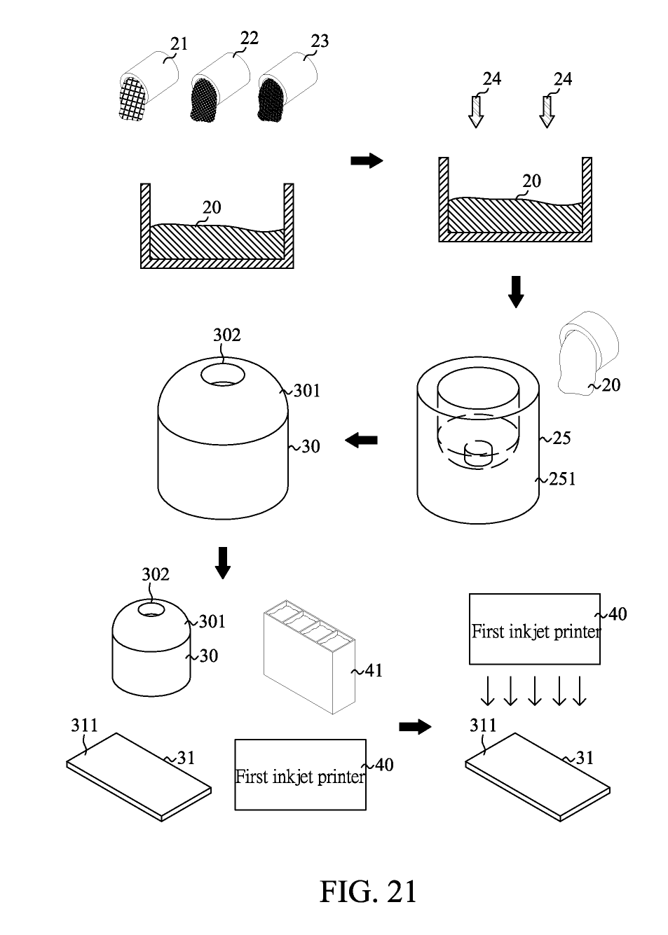

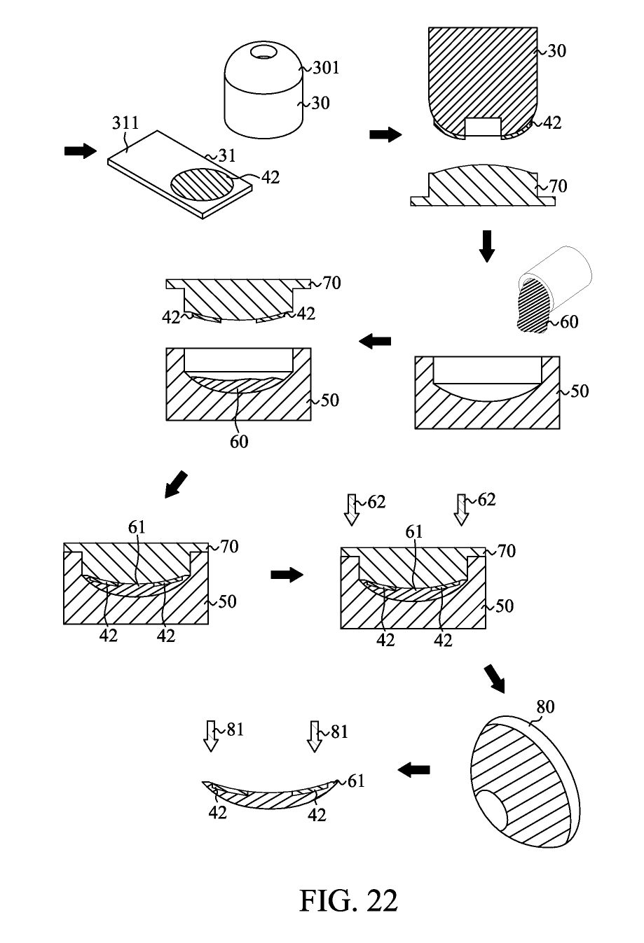

Please refer to FIG. 20 that is a flowchart showing the steps included in a method of manufacturing color contact lens according to a sixth preferred embodiment of the present invention, and to FIGS. 21 and 22 that are pictorial descriptions of the steps in the flowchart of FIG. 20. The following is a detailed description of the steps in the sixth preferred embodiment, which are numbered from (a) to (i) herein for ease of reference.

Step (a): Provide a rubber pad 30 and a printing board 31, and fill C/M/Y/B coloring agents 41 in a first inkjet printer 40. Since the rubber pad 30 is manufactured and shaped and the printing board 31 is constructed in the same manner as described in the fifth preferred embodiment, they are not repeatedly described herein.

Step (b): Use CAD software to output a finished color pattern, and cause the first inkjet printer 40 to jet the C/M/Y/B coloring agents 41 corresponding to the color pattern to form a color image layer 42 on the printing surface 311 of the printing board 31. The C/M/Y/B coloring agents 41 include four colors, namely, cyan, magenta, yellow and black colors, and the four coloring agents 41 are filled in four separate ink cartridges (not shown) of the first inkjet printer 40.

After the first inkjet printer 40 has jetted the C/M/Y/B coloring agents 41, the color image layer 42 formed on the printing surface 311 of the printing board 31 can be compared with the color pattern shown on the computer to check the color image layer for the integrity thereof, so as to lower the defect rate of the produced contact lens.

Step (c): Transfer the color image layer 42 from the printing surface 311 onto the pressure bearing surface 301 of the rubber pad 30.

Step (d): Press the rubber pad 30 against an outer surface of a convex mold 70, so that the color image layer 42 is transferred from the rubber pad 30 onto the outer surface of the convex mold 70. When pressing the rubber pad 30 against the convex mold 70, the hollow opening 302 on the rubber pad 30 prevents a central area of the outer surface of the convex mold 70 from contacting with the color image layer 42. Further, in the process of pressing the rubber pad 30 against the convex mold 70, the hollow opening 302 of the rubber pad 30 also helps in venting air to thereby prevent air bubbles from forming between the color image layer 42 and the outer surface of the convex mold 70. In this way, the risk of having blurs or white spaces formed in the color image layer 42 can be reduced.

Step (e): Inject a lens material 60 into a concave mold 50. In the illustrated preferred embodiment, the lens material 60 is a hydroxyethyl methacrylate (HEMA) based hydrogel material.

Step (f): Press the convex mold 70 against the concave mold 50 to form a lens layer 61 on a surface of the color image layer 42.

Step (g): Subject the color image layer 42 and the lens layer 61 to a curing process 62 to form a color contact lens 80. Since the curing process 62 is the same as that in the fifth preferred embodiment, it is not repeatedly described herein.

Step (h): Wait until the concave mold 50 and the convex mold 70 are cooled, and then remove the color contact lens 80 from the molds. When the concave mold 50 and the convex mold 70 are pressed against each other, they will have a raised temperature. Therefore, wait until the two molds 50, 70 are cooled and then remove the color contact 80 from the molds.

Step (i): Subject the color contact lens 80 to a hydration process 81. Since the hydration process 81 is the same as that in the fifth preferred embodiment, it is not repeatedly described herein.

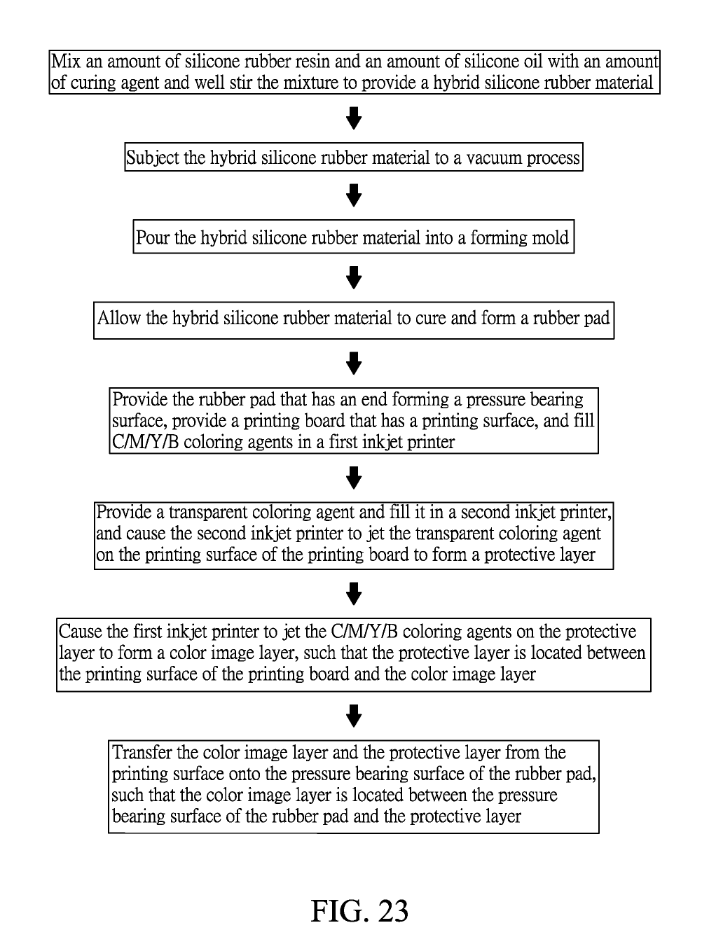

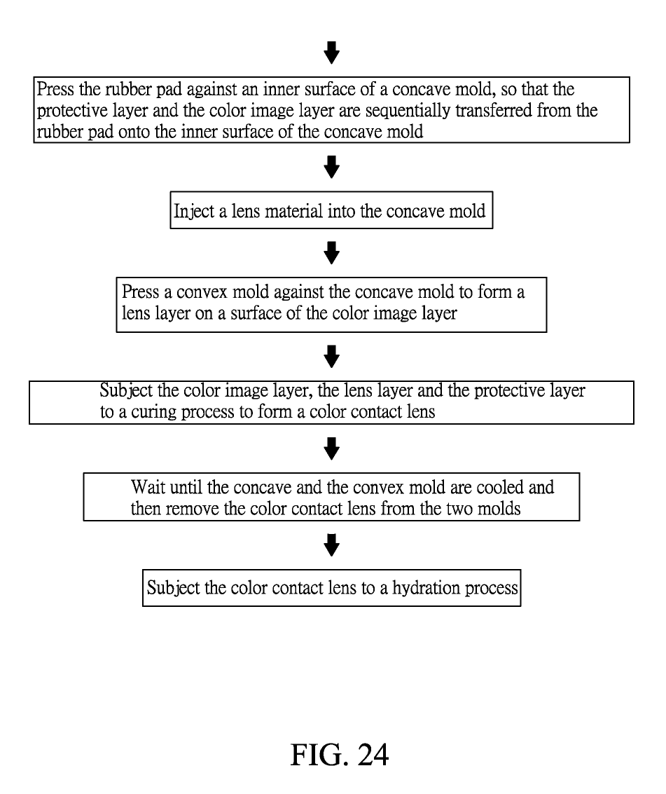

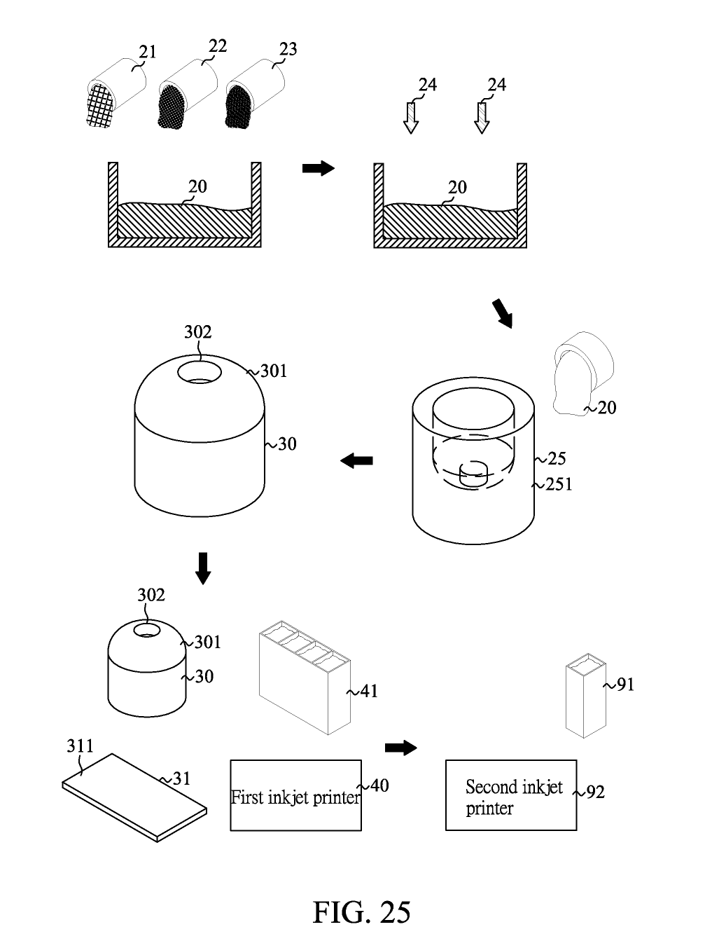

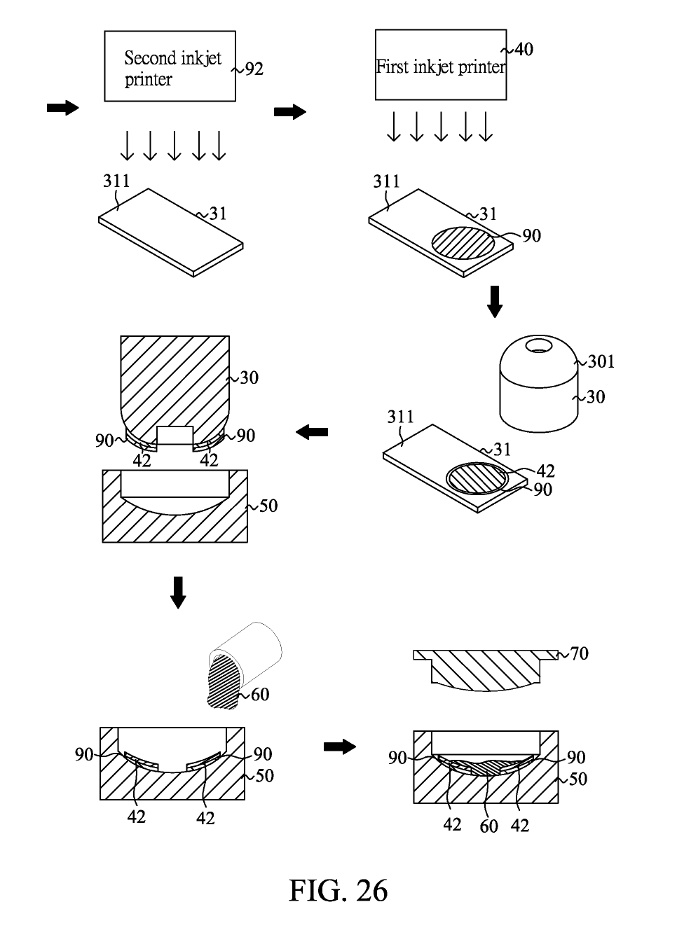

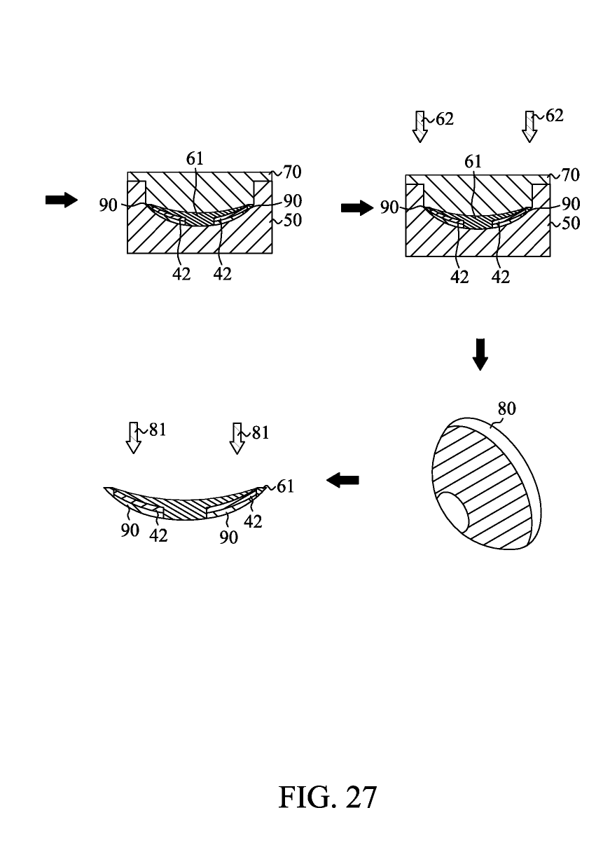

Please refer to FIGS. 23 and 24 that together present a flowchart showing the steps included in a method of manufacturing color contact lens according to a seventh preferred embodiment of the present invention, and to FIGS. 25 to 27 that are pictorial descriptions of the steps in the flowchart of FIGS. 23 and 24. The seventh preferred embodiment is different from the fifth preferred embodiment in that the color contact lens 80 manufactured according to the steps of the seventh preferred embodiment further includes a protective layer 90. The following is a detailed description of the steps in the seventh preferred embodiment, which are numbered from (a) to (j) herein for ease of reference.

Step (a): Provide a rubber pad 30 and a printing board 31, and fill C/M/Y/B coloring agents 41 in a first inkjet printer 40. Since the rubber pad 30 is manufactured and shaped and the printing board 31 is constructed in the same manner as described in the fifth preferred embodiment, they are not repeatedly described herein.

Step (b): Provide a transparent coloring agent 91 and fill it in a second inkjet printer 92, and cause the second inkjet printer 92 to jet the transparent coloring agent 91 on the printing surface 311 of the printing board 31 to form a protective layer 90.

Step (c): Cause the first inkjet printer 40 to jet the C/M/Y/B coloring agents 41 corresponding to a color pattern on a computer to form a color image layer 42 on the protective layer 90, such that the protective layer 90 is located between the printing surface 311 of the printing board 31 and the color image layer 42. The C/M/Y/B coloring agents 41 include four colors, namely, cyan, magenta, yellow and black colors, and the four coloring agents 41 are filled in four separate ink cartridges (not shown) of the first inkjet printer 40.

After the first inkjet printer 40 has jetted the C/M/Y/B coloring agents 41, the color image layer 42 formed on the protective layer 90 can be compared with the color pattern shown on the computer to check the color image layer for the integrity thereof, so as to lower the defect rate of the produced contact lens.

Step (d): Transfer the color image layer 42 and the protective layer 90 from the printing surface 311 onto the pressure bearing surface 301 of the rubber pad 30, such that the color image layer 42 is located between the pressure bearing surface 301 of the rubber pad 30 and the protective layer 90.

Step (e): Press the rubber pad 30 against an inner surface of a concave mold 50, so that the protective layer 90 and the color image layer 42 are sequentially transferred from the rubber pad 30 onto the inner surface of the concave mold 50.

When pressing the rubber pad 30 against the concave mold 50, the hollow opening 302 on the rubber pad 30 provides the same functions as those described in the fifth preferred embodiment. Thus, the functions provided by the hollow opening 302 are not repeatedly described herein.

Step (f): Inject a lens material 60 into the concave mold 50. In the illustrated preferred embodiment, the lens material 60 is a hydroxyethyl methacrylate (HEMA) based hydrogel material.

Step (g): Press a convex mold 70 against the concave mold 50 to form a lens layer 61 on a surface of the color image layer 42. In this manner, the color image layer 42 is located between the protective layer 90 and the lens layer 61, such that all the colors of the color image layer 42 can be completely shown without the risk of peeling off easily. Further, since the pigments of the color image layer 42 are not in direct contact with the wearer's cornea, the contact lens is more comfortable and safer for wearing.

Step (h): Subject the color image layer 42, the lens layer 61 and the protective layer 90 to a curing process 62 to form a color contact lens 80. In the curing process 62, the color image layer 42, the lens layer 61 and the protective layer 90 are exposed to heat radiation, ultraviolet (UV) radiation, microwave radiation or ionizing radiation, so that they are cured to form the color contact lens 80.

Step (i): Wait until the concave mold 50 and the convex mold 70 are cooled, and then remove the color contact lens 80 from the molds. When the concave mold 50 and the convex mold 70 are pressed against each other, they will have a raised temperature. Therefore, wait until the two molds 50, 70 are cooled and then remove the color contact 80 from the molds.

Step (j): Subject the color contact lens 80 to a hydration process 81. Since the hydration process 81 is the same as that in the fifth preferred embodiment, it is not repeatedly described herein.

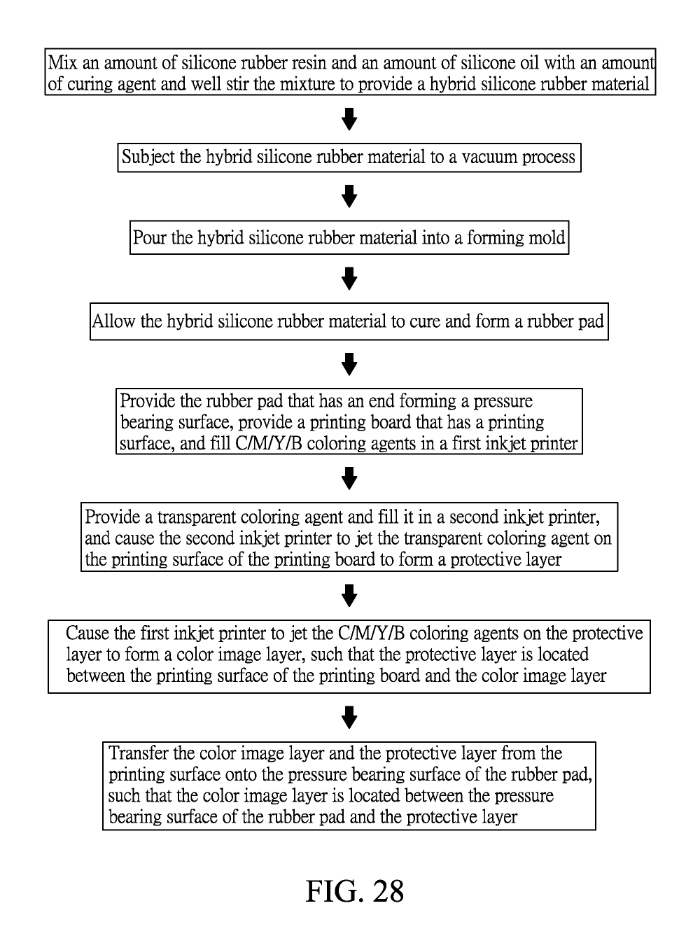

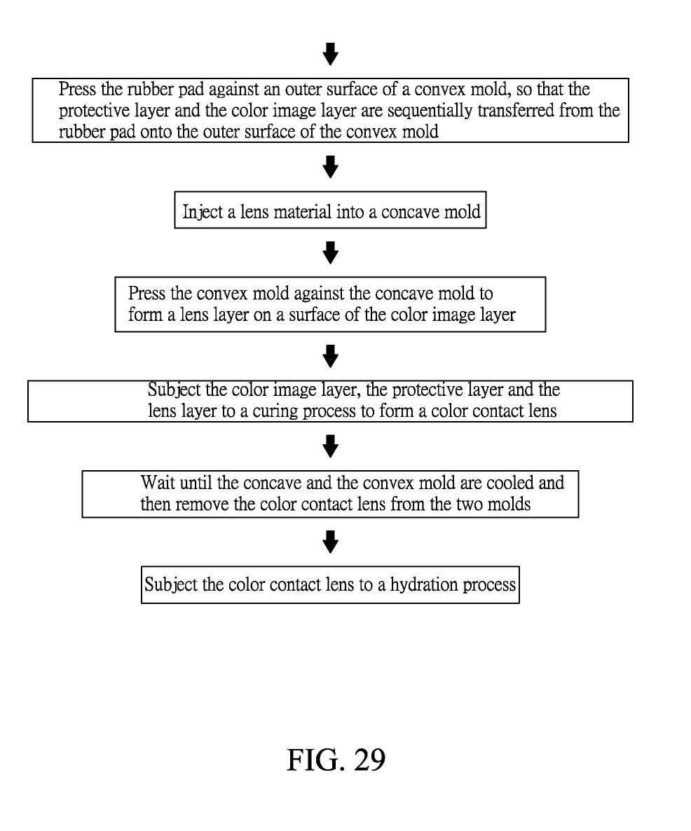

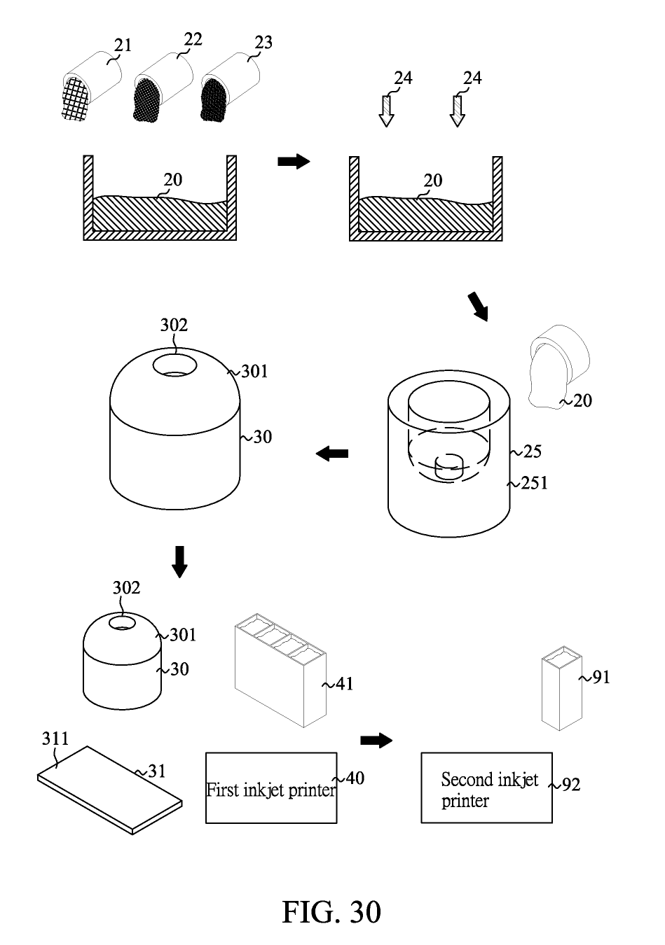

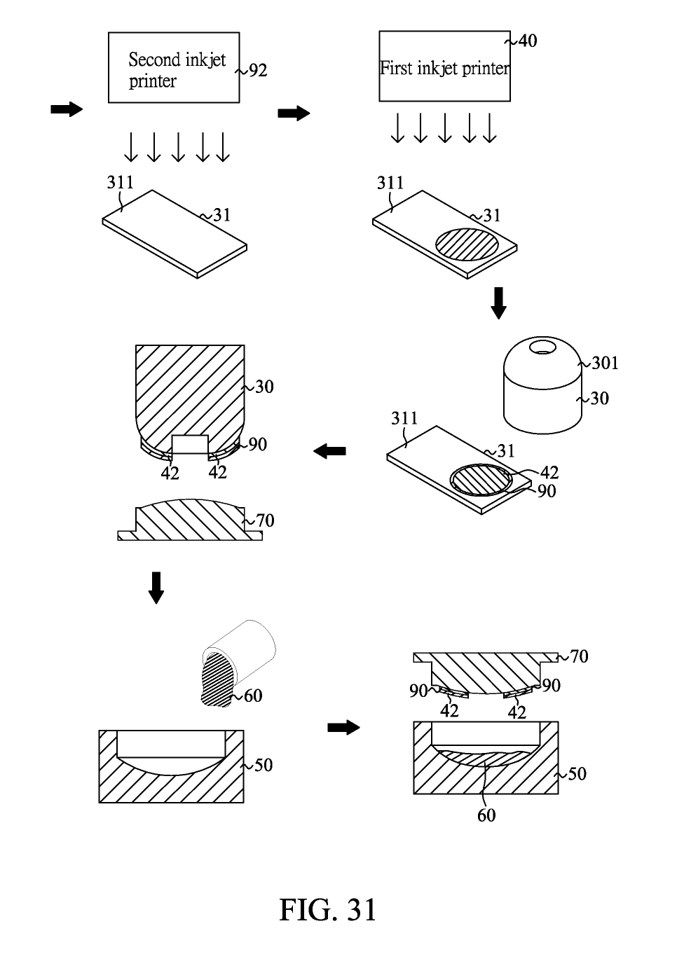

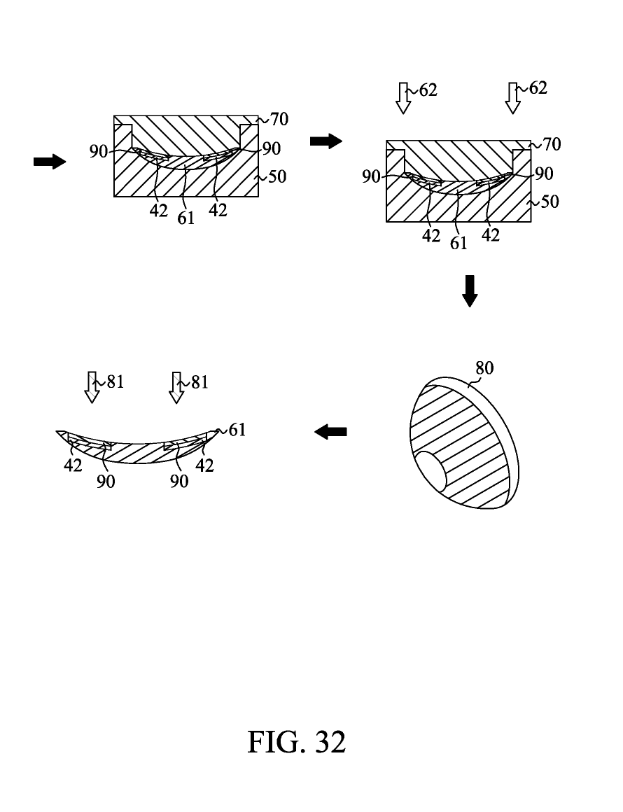

Please refer to FIGS. 28 and 29 that together present a flowchart showing the steps included in a method of manufacturing color contact lens according to an eighth preferred embodiment of the present invention, and to FIGS. 30 to 32 that are pictorial descriptions of the steps in the flowchart of FIGS. 28 and 29. The eighth preferred embodiment is different from the sixth preferred embodiment in that the color contact lens 80 manufactured according to the steps of the eighth preferred embodiment includes a protective layer 90. The following is a detailed description of the steps in the eighth preferred embodiment, which are numbered from (a) to (j) herein for ease of reference.

Step (a): Provide a rubber pad 30 and a printing board 31, and fill C/M/Y/B coloring agents 41 in a first inkjet printer 40. Since the rubber pad 30 is manufactured and shaped and the printing board 31 is constructed in the same manner as described in the fifth preferred embodiment, they are not repeatedly described herein.

Step (b): Provide a transparent coloring agent 91 and fill it in a second inkjet printer 92, and cause the second inkjet printer 92 to jet the transparent coloring agent 91 on the printing surface 311 of the printing board 31 to form a protective layer 90.

Step (c): Cause the first inkjet printer 40 to jet the C/M/Y/B coloring agents 41 corresponding to a color pattern on a computer to form a color image layer 42 on the protective layer 90, such that the protective layer 90 is located between the printing surface 311 of the printing board 31 and the color image layer 42. The C/M/Y/B coloring agents 41 include four colors, namely, cyan, magenta, yellow and black colors, and the four coloring agents 41 are filled in four separate ink cartridges (not shown) of the first inkjet printer 40.

After the first inkjet printer 40 has jetted the C/M/Y/B coloring agents 41, the color image layer 42 formed on the protective layer 90 can be compared with the color pattern shown on the computer to check the color image layer for the integrity thereof, so as to lower the defect rate of the produced contact lens.

Step (d): Transfer the color image layer 42 and the protective layer 90 from the printing surface 311 onto the pressure bearing surface 301 of the rubber pad 30, such that the color image layer 42 is located between the pressure bearing surface 301 of the rubber pad 30 and the protective layer 90.

Step (e): Press the rubber pad 30 against an outer surface of a convex mold 70, so that the protective layer 90 and the color image layer 42 are sequentially transferred from the rubber pad 30 onto the outer surface of the convex mold 70. When pressing the rubber pad 30 against the convex mold 70, the hollow opening 302 on the rubber pad 30 provides the same functions as those described in the sixth preferred embodiment. Thus, the functions provided by the hollow opening 302 are not repeatedly described herein.

Step (f): Inject a lens material 60 into a concave mold 50. In the illustrated preferred embodiment, the lens material 60 is a hydroxyethyl methacrylate (HEMA) based hydrogel material.

Step (g): Press the convex mold 70 against the concave mold 50 to form a lens layer 61 on a surface of the color image layer 42. In this manner, the color image layer 42 is located between the protective layer 90 and the lens layer 61, such that all the colors of the color image layer 42 can be completely shown without the risk of peeling off easily. Further, since the pigments of the color image layer 42 are not in direct contact with the wearer's cornea, the contact lens is more comfortable and safer for wearing.

Step (h): Subject the color image layer 42, the lens layer 61 and the protective layer 90 to a curing process 62 to form a color contact lens 80. Since the curing process 62 is the same as that in the seventh preferred embodiment, it is not repeatedly described herein.

Step (i): Wait until the concave mold 50 and the convex mold 70 are cooled, and then remove the color contact lens 80 from the molds. When the concave mold 50 and the convex mold 70 are pressed against each other, they will have a raised temperature. Therefore, wait until the two molds 50, 70 are cooled and then remove the color contact 80 from the molds.

Step (j): Subject the color contact lens 80 to a hydration process 81. Since the hydration process 81 is the same as that in the fifth preferred embodiment, it is not repeatedly described herein.

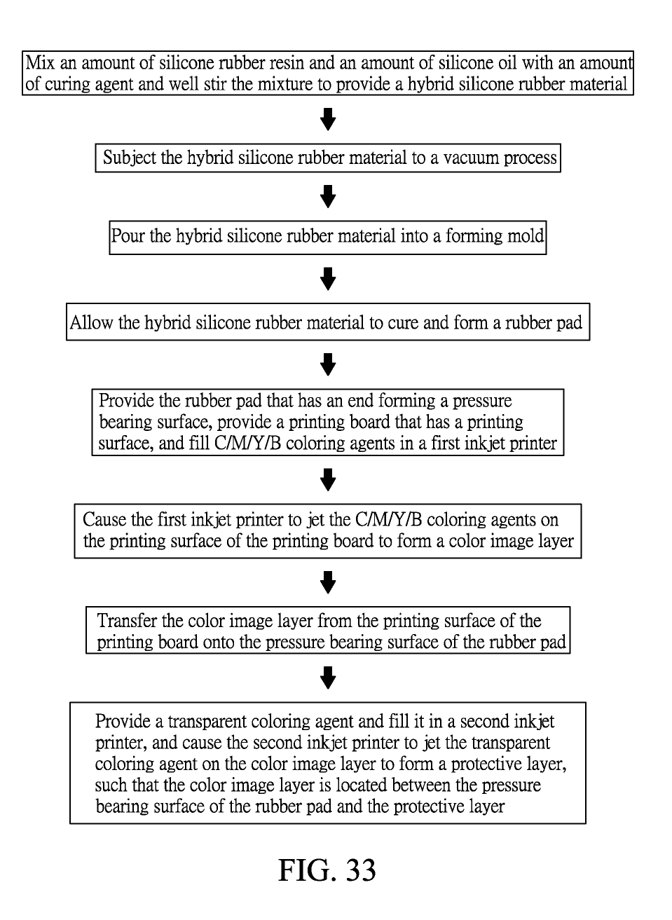

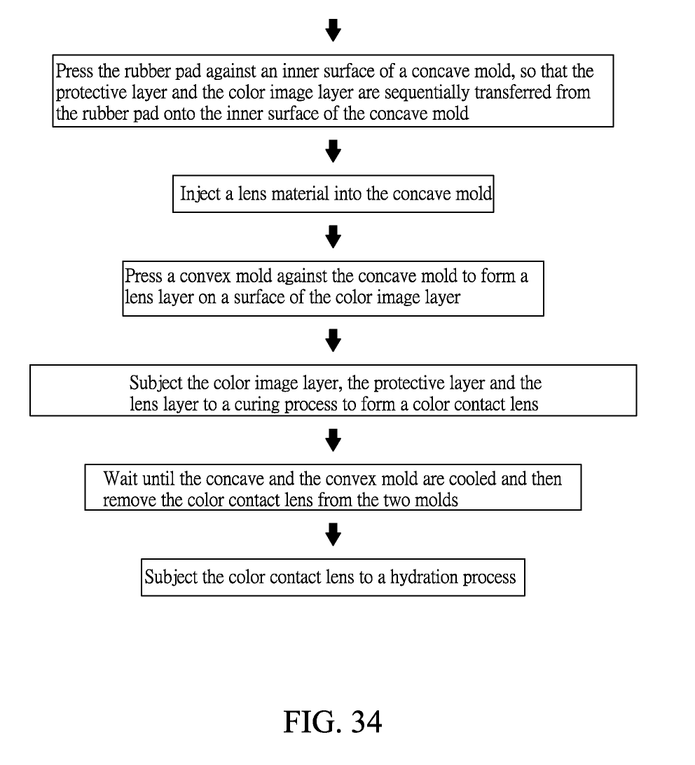

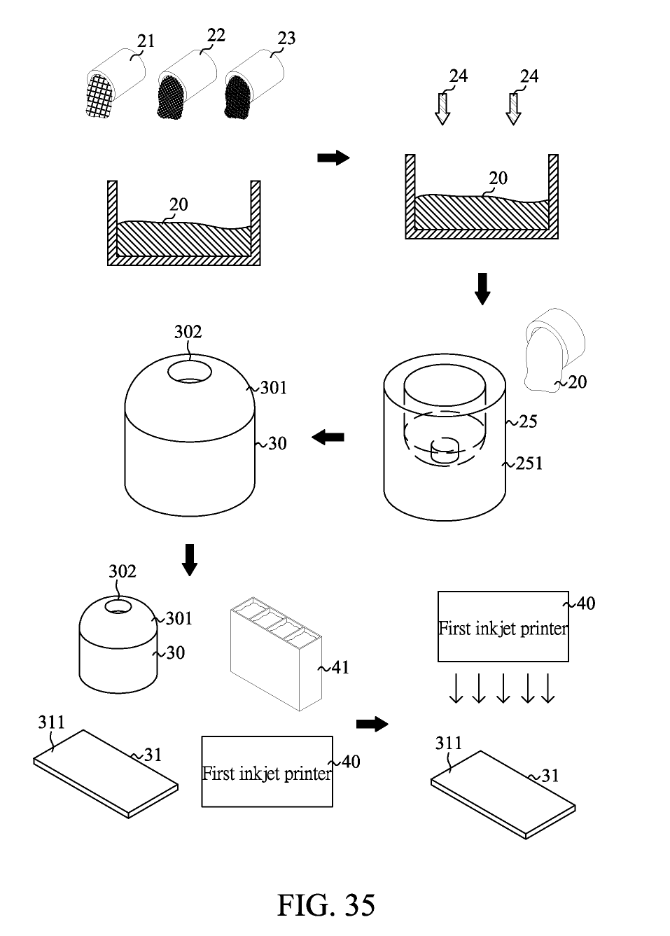

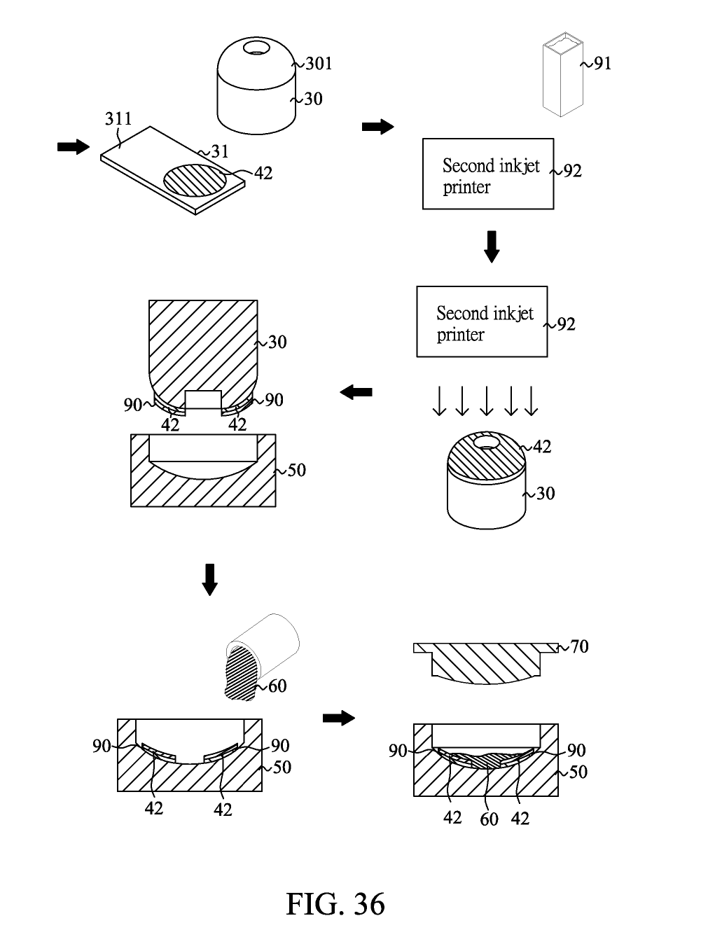

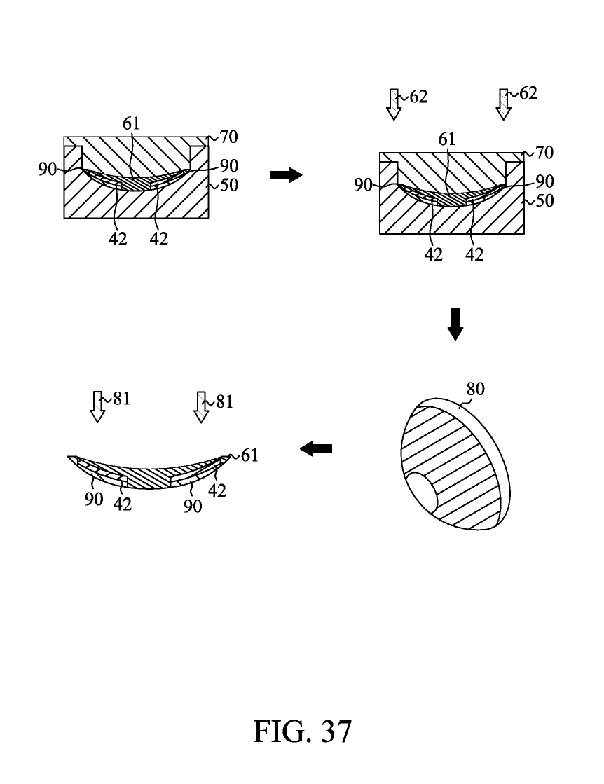

Please refer to FIGS. 33 and 34 that together present a flowchart showing the steps included in a method of manufacturing color contact lens according to a ninth preferred embodiment of the present invention, and to FIGS. 35 to 37 that are pictorial descriptions of the steps in the flowchart of FIGS. 33 and 34. The ninth preferred embodiment is different from the fifth preferred embodiment in that, after the color image layer 42 is transferred from the printing surface 311 of the printing board 31 onto the pressure bearing surface 301 of the rubber pad 30, a second inkjet printer 92 is caused to jet a transparent coloring agent 91 on a surface of the color image layer 42 to form a protective layer 90, such that the color image layer 42 is located between the pressure bearing surface 301 of the rubber pad 30 and the protective layer 90. Thereafter, the rubber pad 30 is pressed against an inner surface of a concave mold 50, so that the protective layer 90 and the color image layer 42 are sequentially transferred onto the inner surface of the concave mold 50. Since all other steps in the ninth preferred embodiment are the same as those in the fifth preferred embodiment, they are not repeatedly described herein.

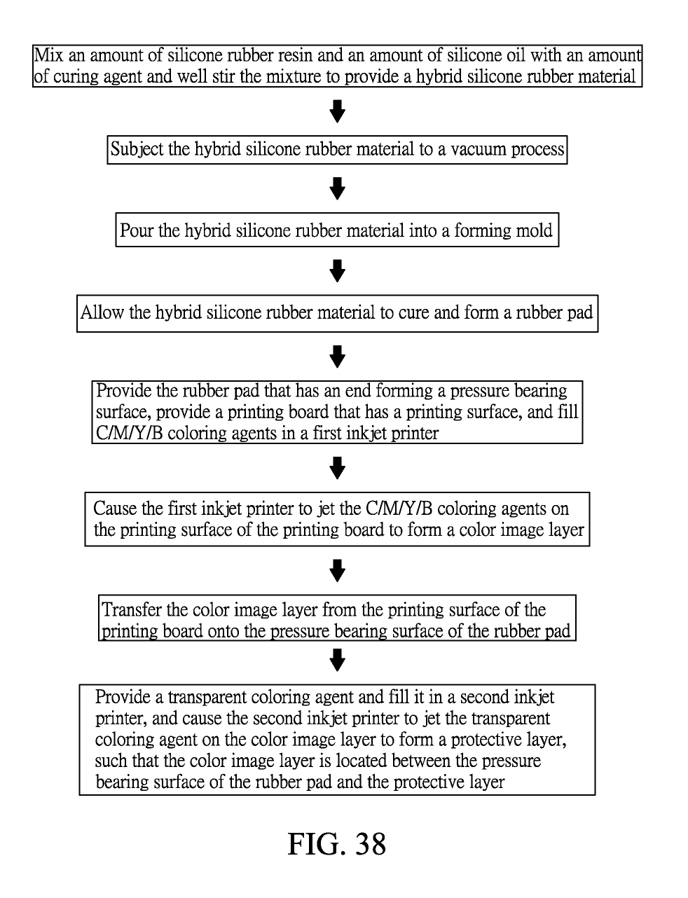

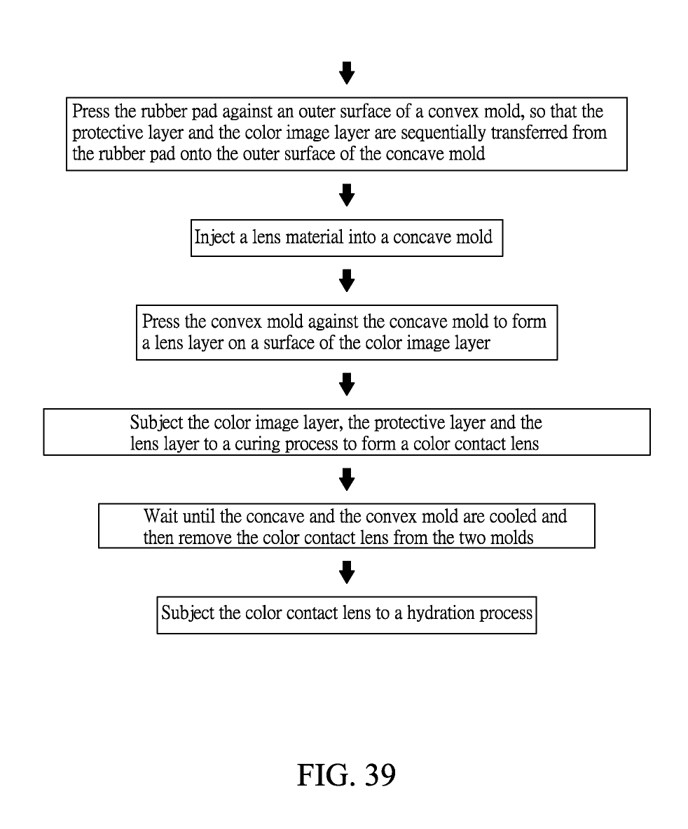

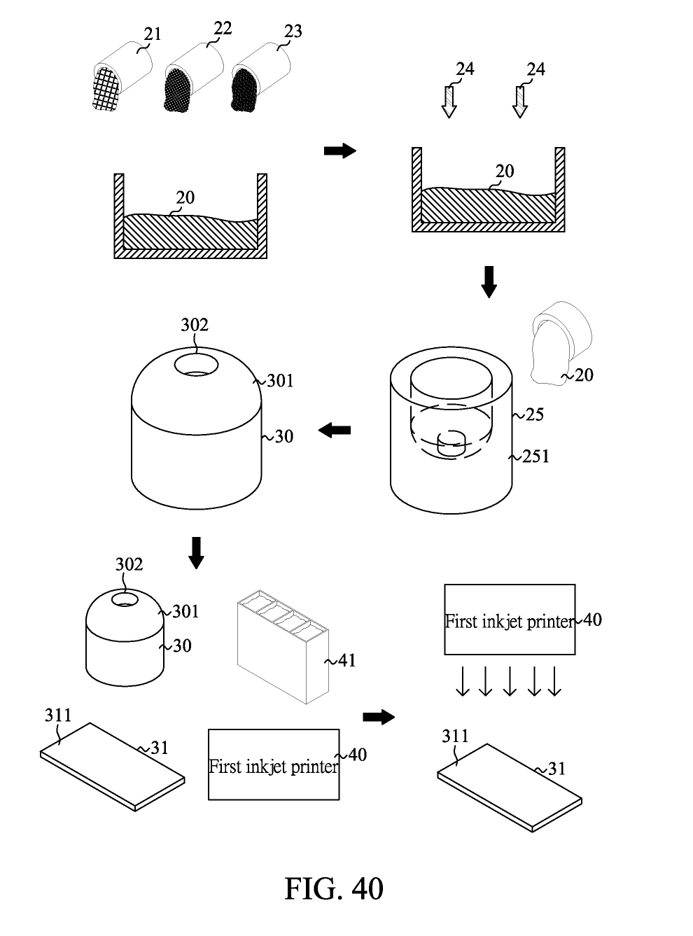

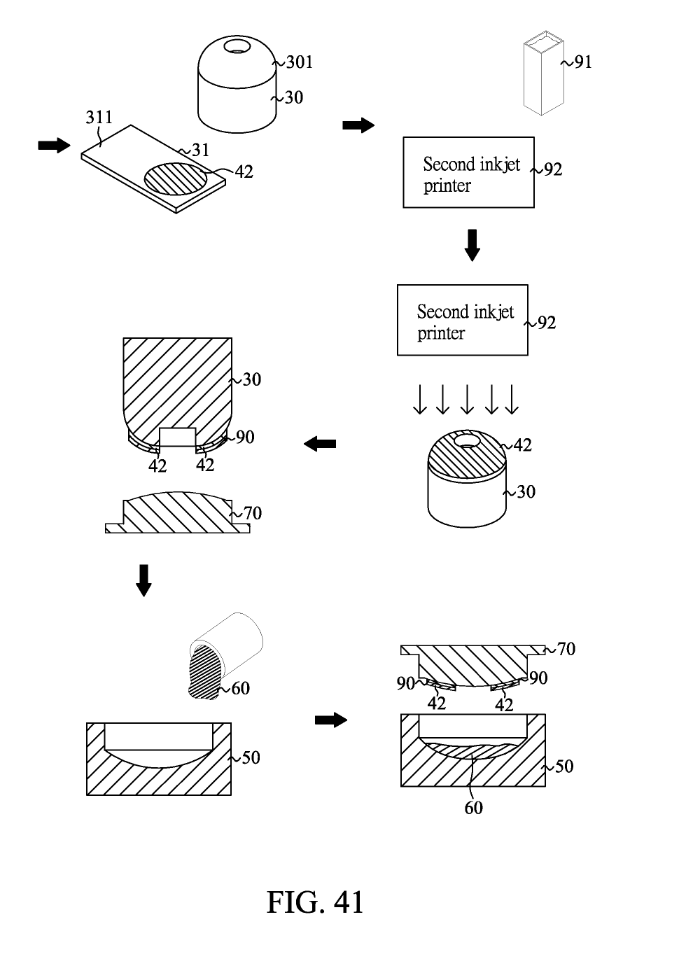

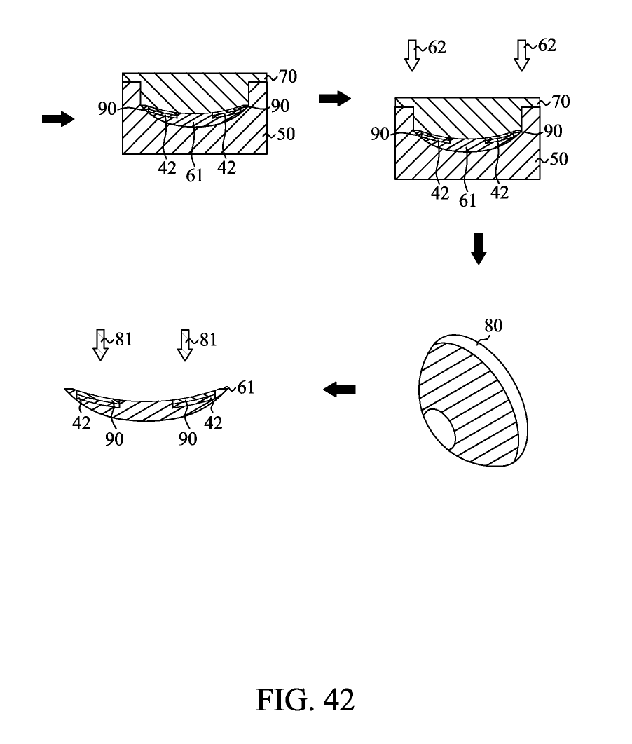

Please refer to FIGS. 38 and 39 that together present a flowchart showing the steps included in a method of manufacturing color contact lens according to a tenth preferred embodiment of the present invention, and to FIGS. 40 to 42 that are pictorial descriptions of the steps in the flowchart of FIGS. 38 and 39. The tenth preferred embodiment is different from the sixth preferred embodiment in that, after the color image layer 42 is transferred from the printing surface 311 of the printing board 31 onto the pressure bearing surface 301 of the rubber pad 30, a second inkjet printer 92 is caused to jet a transparent coloring agent 91 on a surface of the color image layer 42 to form a protective layer 90, such that the color image layer 42 is located between the pressure bearing surface 301 of the rubber pad 30 and the protective layer 90. Thereafter, the rubber pad 30 is pressed against an outer surface of a convex mold 70, so that the protective layer 90 and the color image layer 42 are sequentially transferred from the rubber pad 30 onto the outer surface of the convex mold 70. Since all other steps in the tenth preferred embodiment are the same as those in the sixth preferred embodiment, they are not repeatedly described herein.

The method according to the present invention is characterized in that it can be used to handle any fine color pattern designed with CAD for manufacturing a color contact lens. By causing the first inkjet printer to jet the C/M/Y/B coloring agents corresponding to the predetermined color pattern to form a color image layer on the printing surface of the printing board, transferring the color image layer onto the pressure bearing surface of the rubber pad, and pressing the rubber pad against a predetermined mold surface, it is able to quickly complete a multicolor pattern for a contact lens in one operation without increasing the thickness of the completed color image layer, and a lot of manufacturing cost and time is saved. When a large number of rubber pads and printing boards are provided, the first inkjet printer can also be used to jet the C/M/Y/B coloring agents on all the printing boards at the same time, and the color image layers on the printing boards are then simultaneously transferred onto the rubber pads. In this manner, the color contact lens can be mass-produced at reduced manufacturing cost to have good competitiveness in the market.

The method of the present invention is also characterized in that, after the first inkjet printer jets the C/M/Y/B coloring agents on the printing surface of the printing board, the color image layer so formed can be checked via a computer for its integrity, so as to reduce the defect rate of the finished color contact lenses.

Further, by causing the second inkjet printer to jet the transparent coloring agent on the printing surface of the printing board to form the protective layer, causing the first inkjet printer to jet the C/M/Y/B coloring agents on the surface of the protective layer to form the color image layer, transferring the protective layer and the color image layer onto the pressure bearing surface of the rubber pad, pressing the rubber pad against the concave mold to transfer the color image layer and the protective layer onto the inner surface of the concave mold, injecting the lens material into the concave mold, and pressing the convex mold against the concave mold to form the lens layer, the color image layer is located between the lens layer and the protective layer to form the color contact lens. In this manner, all the colors of the color image layer can be completely shown without the risk of peeling off easily. Further, since the pigments of the color image layer are not in direct contact with the wearer's cornea, the color contact lens is more comfortable and safer for wearing.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of manufacturing color contact lens, comprising the steps of:
providing a rubber pad having a pressure bearing surface, and filling C/M/Y/B coloring agents in a first inkjet printer;
causing the first inkjet printer to jet the C/M/Y/B coloring agents on the pressure bearing surface of the rubber pad to form a color image layer;
pressing the rubber pad against an inner surface of a concave mold to transfer the color image layer from the rubber pad onto the inner surface of the concave mold;
injecting a lens material into the concave mold;
pressing a convex mold against the concave mold to form a lens layer on a surface of the color image layer; and
subjecting the color image layer and the lens layer to a curing process to form a color contact lens.

2. The method of manufacturing color contact lens as claimed in claim 1, wherein the rubber pad is manufactured via the following steps:
mixing an amount of silicone rubber resin and an amount of silicone oil with an amount of curing agent, and well stirring the mixture to provide a hybrid silicone rubber material;
subjecting the hybrid silicone rubber material to a vacuum process;
pouring the hybrid silicone rubber material into a forming mold; and
allowing the hybrid silicone rubber material to cure and form the rubber pad.

3. A method of manufacturing color contact lens, comprising the steps of:
providing a rubber pad having a pressure bearing surface, and filling C/M/Y/B coloring agents in a first inkjet printer;
causing the first inkjet printer to jet the C/M/Y/B coloring agents on the pressure bearing surface of the rubber pad to form a color image layer;
pressing the rubber pad against an outer surface of a convex mold to transfer the color image layer from the rubber pad onto the outer surface of the convex mold;
injecting a lens material into a concave mold;
pressing the convex mold against the concave mold to form a lens layer on a surface of the color image layer; and
subjecting the color image layer and the lens layer to a curing process to form a color contact lens.

4. The method of manufacturing color contact lens as claimed in claim 3, wherein
the rubber pad is manufactured via the following steps:
mixing an amount of silicone rubber resin and an amount of silicone oil with an amount of curing agent, and well stirring the mixture to provide a hybrid silicone rubber material;
subjecting the hybrid silicone rubber material to a vacuum process;
pouring the hybrid silicone rubber material into a forming mold; and
allowing the hybrid silicone rubber material to cure and form the rubber pad.

5. A method of manufacturing color contact lens, comprising the steps of:
providing a rubber pad having a pressure bearing surface and a printing board having a printing surface, and filling C/M/Y/B coloring agents in a first inkjet printer;
causing the first inkjet printer to jet the C/M/Y/B coloring agents on the printing surface of the printing board to form a color image layer;
transferring the color image layer from the printing surface onto the pressure bearing surface of the rubber pad;
pressing the rubber pad against an inner surface of a concave mold to transfer the color image layer from the rubber pad onto the inner surface of the concave mold;
injecting a lens material into the concave mold;
pressing a convex mold against the concave mold to form a lens layer on a surface of the color image layer; and
subjecting the color image layer and the lens layer to a curing process to form a color contact lens.

6. The method of manufacturing color contact lens as claimed in claim 5, wherein the rubber pad is manufactured via the following steps:
mixing an amount of silicone rubber resin and an amount of silicone oil with an amount of curing agent, and well stirring the mixture to provide a hybrid silicone rubber material;
subjecting the hybrid silicone rubber material to a vacuum process;
pouring the hybrid silicone rubber material into a forming mold; and
allowing the hybrid silicone rubber material to cure and form the rubber pad.

7. The method of manufacturing color contact lens as claimed in claim 5, wherein the printing board includes a thermoplastic elastomeric film and a phenol formaldehyde resin plate.

8. A method of manufacturing color contact lens, comprising the steps of:
providing a rubber pad having a pressure bearing surface and a printing board having a printing surface, and filling C/M/Y/B coloring agents in a first inkjet printer;
providing a transparent coloring agent and filling it in a second inkjet printer, and causing the second inkjet printer to jet the transparent coloring agent on the printing surface of the printing board to form a protective layer;
causing the first inkjet printer to jet the C/M/Y/B coloring agents on a surface of the protective layer to form a color image layer, such that the protective layer is located between printing surface of the printing board and the color image layer;
transferring the color image layer and the protective layer from the printing surface onto the pressure bearing surface of the rubber pad, such that the color image layer is located between the pressure bearing surface of the rubber pad and the protective layer;
pressing the rubber pad against an inner surface of a concave mold, such that the protective layer and the color image layer are sequentially transferred from the rubber pad onto the inner surface of the concave mold;
injecting a lens material into the concave mold;
pressing a convex mold against the concave mold to form a lens layer on a surface of the color image layer; and
subjecting the color image layer, the protective layer and the lens layer to a curing process to form a color contact lens.

9. The method of manufacturing color contact lens as claimed in claim 8, wherein the rubber pad is manufactured via the following steps:
mixing an amount of silicone rubber resin and an amount of silicone oil with an amount of curing agent, and well stirring the mixture to provide a hybrid silicone rubber material;
subjecting the hybrid silicone rubber material to a vacuum process;
pouring the hybrid silicone rubber material into a forming mold; and
allowing the hybrid silicone rubber material to cure and form the rubber pad.

10. The method of manufacturing color contact lens as claimed in claim 8, wherein the printing board includes a thermoplastic elastomeric film and a phenol formaldehyde resin plate.

11. A method of manufacturing color contact lens, comprising the steps of:
providing a rubber pad having a pressure bearing surface and a printing board having a printing surface, and filling C/M/Y/B coloring agents in a first inkjet printer;
causing the first inkjet printer to jet the C/M/Y/B coloring agents on the printing surface of the printing board to form a color image layer thereon;
transferring the color image layer from the printing surface onto the pressure bearing surface of the rubber pad;
providing a transparent coloring agent and filling it in a second inkjet printer, and causing the second inkjet printer to jet the transparent coloring agent on the a surface of the color image layer to form a protective layer, such that the color image layer is located between the pressure bearing surface of the rubber pad and the protective layer;
pressing the rubber pad against an inner surface of a concave mold, such that the protective layer and the color image layer are sequentially transferred from the rubber pad onto the inner surface of the concave mold;
injecting a lens material into the concave mold;
pressing a convex mold against the concave mold to form a lens layer on a surface of the color image layer; and
subjecting the color image layer, the protective layer and the lens layer to a curing process to form a color contact lens.

12. The method of manufacturing color contact lens as claimed in claim 11, wherein the rubber pad is manufactured via the following steps:
mixing an amount of silicone rubber resin and an amount of silicone oil with an amount of curing agent, and well stirring the mixture to provide a hybrid silicone rubber material;
subjecting the hybrid silicone rubber material to a vacuum process;
pouring the hybrid silicone rubber material into a forming mold; and
allowing the hybrid silicone rubber material to cure and form the rubber pad.

13. The method of manufacturing color contact lens as claimed in claim 11, wherein the printing board includes a thermoplastic elastomeric film and a phenol formaldehyde resin plate.
